(19) United States
(12) Patent Application Publication
(10) Pub. No.: US 2026/0329308 A1
(43) Pub. Date: Oct. 22, 2026

(54) ROBOT-COMPATIBLE BUILDING, METHOD AND SYSTEM FOR CONTROLLING A ROBOT TRAVELING IN A BUILDING

(71) Applicant: NAVER CORPORATION, Seongnam-si (KR)

(72) Inventors: Su Re BAK, Seongnam-si (KR); Ka Hyeon KIM, Seongnam-si (KR); Yo Han CHO, Seongnam-si (KR); Yong Kyung OH, Seongnam-si (KR)

(73) Assignee: NAVER CORPORATION, Seongnam-si (KR)

(21) Appl. No.: 19/692,172

(22) Filed: May 29, 2026

Related U.S. Application Data
(63) Continuation of application No. PCT/KR2024/004867, filed on Apr. 11, 2024.

(30) Foreign Application Priority Data
Nov. 29, 2023 (KR) 10-2023-0169544

(51) Int. Cl. G05D 1/69; G05D 1/246; G05D 1/656; G05D 101/00; G05D 107/60

(52) U.S. Cl. CPC G05D 1/69; G05D 1/246; G05D 1/656; G05D 2101/22; G05D 2107/60

(57) ABSTRACT

The present disclosure relates to a robot-compatible building, and a method and system for controlling a robot traveling in a building.

More specifically, the present disclosure relates to a method and system for controlling a robot that enables a robot and a person to coexist together in the same space and to provide useful services to the person.

The present disclosure relates to a method for controlling a robot traveling in a space based on a node map including a plurality of nodes, and may comprise: receiving location information of the robot traveling in the space along a preset travel path including a plurality of nodes; identifying a node at which the robot is located based on the location information; and transmitting, to the robot, a control parameter assigned to the identified node when a control parameter related to behavior control of the robot is assigned to the identified node, so that the robot performs a behavior according to the control parameter.

### CROSS-REFERENCE TO RELATED APPLICATION

This application is a continuation of, and claims the benefit of priority under 35 U.S.C. §365(c) from International Application No. PCT/KR 2024/004867, filed on Apr. 11, 2024, in the World Intellectual Property Organization (WIPO), which designates the United States of America and claims priority benefit of Korean Patent Application No. 10-2023-0169544, filed on Nov. 29, 2023, the disclosures of each of which are incorporated herein by reference in their entirety.

### TECHNICAL FIELD

The present disclosure relates to a method and system for controlling a robot applicable to a robot-compatible building. In particular, the present disclosure relates to a method and system for controlling a behavior of a robot based on a location of the robot.

### BACKGROUND

As technology advances, various service devices are emerging, and in particular, technology development for robots that perform various tasks or services has been actively carried out in recent years.

Furthermore, in recent years, as artificial intelligence technology, cloud technology, and the like have advanced, it has become possible to control robots more precisely and safely, and accordingly, the utilization of robots has been gradually increasing.

In particular, due to advances in technology, robots have reached a level where they can safely coexist with humans in indoor spaces.

Accordingly, robots are recently replacing human work or tasks, and in particular, various methods for robots to directly provide services to people in indoor spaces are being actively studied.

For example, in public places such as airports, train stations, and department stores, robots are providing navigation services, and in restaurants, robots are providing serving services.

Furthermore, in office spaces, shared residential spaces, and similar environments, robots are providing delivery services for mail, parcels, and the like.

In addition, robots are providing a variety of services such as cleaning services, security services, and logistics processing services, and the types and scope of services provided by robots are expected to increase exponentially in the future, and the level of service provision is also expected to continue to advance.

Such robots are providing a variety of services not only in outdoor spaces but also in indoor spaces of buildings such as offices, apartments, department stores, schools, hospitals, and amusement facilities, and in this case, the robots are controlled to move through the indoor spaces of the buildings and provide a variety of services.

Research on methods for controlling the driving of robots in order to provide services within buildings is being actively conducted.

However, if there is a constraint on a safe travel path, the robot's driving must be stopped in order to control the behavior of the robot other than driving according to conventional schemes.

Accordingly, there is a need for a method of controlling the behavior of the robot in addition to the driving control of the robot.

### SUMMARY

A technical problem addressed by the present disclosure is that, in existing approaches that focus only on driving control of a robot along a travel path, the driving of the robot may need to be stopped in order to control a behavior of the robot other than driving. As a technical solution, the present disclosure provides a technical improvement in which a control parameter related to behavior control is assigned to a node of a node map, such that the behavior of the robot may be controlled together with the driving of the robot based on a location of the robot, without requiring the driving of the robot to be stopped.

Some example embodiments of the present disclosure include a method and system for controlling a robot traveling in a building.

In particular, some example embodiments of the present disclosure include a robot control method and system capable of controlling the behavior of the robot together with driving control of the robot.

More specifically, the present disclosure is directed to providing a method and system for controlling a robot that is capable of controlling a behavior of the robot based on a location of the traveling robot.

Some example embodiments of the present disclosure include a method for controlling a robot traveling in a space based on a node map including a plurality of nodes, the method comprising: receiving location information of the robot traveling in the space along a preset travel path including a plurality of nodes; identifying a node at which the robot is located based on the location information; and transmitting, to the robot, a control parameter assigned to the identified node when a control parameter related to behavior control of the robot is assigned to the identified node, so that the robot performs a behavior according to the control parameter.

Some example embodiments of the present disclosure include a robot control system for controlling a robot traveling in a space based on a node map including a plurality of nodes, and the robot control system may comprise: a communication unit configured to receive location information of the robot traveling in the space along a preset travel path including a plurality of nodes; and a control unit configured to identify a node at which the robot is located based on the location information, and transmit, to the robot, a control parameter assigned to the identified node when a control parameter related to behavior control of the robot is assigned to the identified node, so that the robot performs a behavior according to the control parameter.

Some example embodiments of the present disclosure include a computing device configured to execute instructions for performing: receiving location information of the robot traveling in the space along a preset travel path including a plurality of nodes; identifying a node at which the robot is located based on the location information; and transmitting, to the robot, a control parameter assigned to the identified node when a control parameter related to behavior control of the robot is assigned to the identified node, so that the robot performs a behavior according to the control parameter.

A program according to the present disclosure is executed by one or more processes in an electronic device and is stored in a computer-readable recording medium, and may include instructions for performing: receiving location information of the robot traveling in the space along a preset travel path including a plurality of nodes; identifying a node at which the robot is located based on the location information; and transmitting, to the robot, a control parameter assigned to the identified node when a control parameter related to behavior control of the robot is assigned to the identified node, so that the robot performs a behavior according to the control parameter.

Some example embodiments of the present disclosure include a building in which a robot controlled by a cloud server travels, wherein the building comprises a communication unit configured to receive location information of the robot traveling in a space along a preset travel path including a plurality of nodes from the cloud server, and the cloud server may identify a node at which the robot is located based on the location information, and transmit, to the robot, a control parameter assigned to the identified node when a control parameter related to behavior control of the robot is assigned to the identified node, so that the robot performs a behavior according to the control parameter.

A building, a method for controlling a robot traveling in a building, and a system according to the present disclosure control a robot traveling in a space based on a node map including a plurality of nodes, receive location information of the robot traveling in the space along a preset travel path, and may identify a node at which the robot is located based on the location information.

As a result, the present disclosure may control a behavior of a traveling robot based on various locations on a travel path of the robot.

Furthermore, the method and system for controlling a robot according to the present disclosure, by transmitting, to the robot, a control parameter assigned to the identified node when a control parameter related to behavior control of the robot is assigned to the identified node so that the robot performs a behavior according to the control parameter, may control traveling and behavior of the robot in parallel using a node map, and may control the robot to perform a new behavior even when the robot is traveling toward a destination or does not stop at a specific location.

Furthermore, the robot-compatible building according to the present disclosure may utilize technological convergence in which robot, autonomous driving, AI, and cloud technologies are converged and connected, and may provide a new space in which these technologies, robots, and facility infrastructure provided within the building are organically combined.

Furthermore, the robot-compatible building according to the present disclosure may use a cloud server interworking with a plurality of robots to organically control the plurality of robots and facility infrastructure, thereby systematically managing the travel of robots that provide services.

As a result, the robot-compatible building according to the present disclosure may provide various services to people more safely, quickly, and accurately.

### BRIEF DESCRIPTION OF THE DRAWINGS

FIGS. 1, 2, and 3 are conceptual diagrams for explaining a robot-compatible building according to the present disclosure.

FIGS. 4, 5, and 6 are conceptual diagrams for explaining a system for controlling a robot traveling in a robot-compatible building according to the present disclosure and various facilities provided in the robot-compatible building.

FIGS. 7 and 8 are conceptual diagrams for explaining facility infrastructure provided in a robot-compatible building according to the present disclosure.

FIGS. 9 to 11 are conceptual diagrams for explaining a method for estimating a location of a robot traveling in a robot-compatible building according to the present disclosure.

FIG. 12 is a conceptual diagram for explaining a robot control system according to the present disclosure.

FIG. 13 is a flowchart for explaining a method for controlling a robot according to the present disclosure.

FIGS. 14a, 14b, 15, 16, 17, 18a, 18b, 19, and 20 are conceptual diagrams for explaining a method for controlling a behavior of a robot according to a location of the robot using a node map.

### DETAILED DESCRIPTION

Hereinafter, embodiments disclosed in the present specification will be described in detail with reference to the accompanying drawings, wherein the same reference numerals are assigned to the same or similar components regardless of reference numerals, and redundant descriptions thereof will be omitted.

The suffixes “module” and “unit” for components used in the following description are assigned or used interchangeably merely for ease of drafting the specification, and do not, by themselves, have distinct meanings or roles.

In addition, in describing the embodiments disclosed in the present specification, if it is determined that a detailed description of a related known technology may obscure the gist of the embodiments disclosed in the present specification, the detailed description thereof will be omitted.

In addition, the accompanying drawings are only for facilitating understanding of the embodiments disclosed in the present specification, and the technical idea disclosed in the present specification is not limited by the accompanying drawings, and it should be understood that all modifications, equivalents, and substitutes included in the spirit and technical scope of the present disclosure are included.

Terms including ordinal numbers such as first, second, and the like may be used to describe various components, but the components are not limited by the terms.

The terms are used only for the purpose of distinguishing one component from another component.

When a component is referred to as being “connected” or “coupled” to another component, it should be understood that the component may be directly connected or coupled to the other component, but another component may also exist in between.

In contrast, when a component is referred to as being “directly connected” or “directly coupled” to another component, it should be understood that no other component exists in between.

Singular expressions include plural expressions unless the context clearly indicates otherwise.

In the present application, terms such as “comprise” or “have” are intended to designate the existence of features, numbers, steps, operations, components, parts, or combinations thereof described in the specification, and should be understood as not precluding in advance the possibility of the existence or addition of one or more other features, numbers, steps, operations, components, parts, or combinations thereof.

As used herein, a “control parameter” refers to information that is assigned to a node and that is related to controlling a behavior of a robot other than driving of the robot. The term “control parameter” may also be referred to as a “behavior control parameter,” a “behavior control value,” “node behavior information,” or a “control attribute,” and all such expressions are intended to refer to the same concept as “control parameter” as used herein.

As used herein, a “node” refers to a unit position defined on a node map and usable for identifying a location of a robot traveling in a space, and a “node map” refers to a map including a plurality of such nodes and an edge connecting the plurality of nodes. The term “node” may also be referred to as a “map node,” a “location node,” a “travel-path node,” or a “waypoint,” and all such expressions are intended to refer to the same concept as “node” as used herein.

### Technical Improvements Over Prior Art

Prior to the invention disclosed herein, approaches for controlling a robot traveling within a building commonly focused on driving control of the robot along a travel path, in which a behavior of the robot other than driving was controlled separately from the driving control. Under such approaches, in order to control a behavior of the robot other than driving, the driving of the robot could be required to be stopped, which could entail interruption of the travel of the robot toward a destination and degraded efficiency of service provision within the building.

The present specification discloses a control scheme that modifies the manner in which behavior control information is associated with locations of the robot. In particular, a control parameter related to behavior control of the robot may be assigned to a node of a node map, and when the robot is identified as being located at the node to which the control parameter is assigned, the control parameter may be transmitted to the robot so that the robot performs a behavior according to the control parameter. By associating behavior control information with nodes of the node map in this manner, the behavior of the robot may be controlled in parallel with the driving of the robot, and the robot may perform a behavior according to the control parameter even while the robot continues to travel along the preset travel path toward a destination and without the driving of the robot being stopped. This may result in at least one of (i) reduced interruption of the travel of the robot and (ii) improved efficiency of controlling the behavior of the robot together with the driving of the robot within the building.

The foregoing improvements are reflected in the limitations of claim 1, which recites identifying a node at which the robot is located based on location information and transmitting, to the robot, a control parameter assigned to the identified node when a control parameter related to behavior control of the robot is assigned to the identified node, so that the robot performs a behavior according to the control parameter.

The present disclosure relates to a robot-compatible building, and proposes a robot-compatible building in which people and robots can safely coexist, and furthermore, robots can provide beneficial services within the building.

More specifically, the present disclosure provides a method of providing useful services to people by using robots, robot-compatible infrastructure, and various systems for controlling them.

In the building according to the present disclosure, people and a plurality of robots can coexist, and various infrastructure (or facility infrastructure) through which the plurality of robots can freely move within the building may be provided.

In the present disclosure, a building is a structure constructed for continuous residence, living, work, and the like, and may take various forms such as commercial buildings, industrial buildings, institutional buildings, and residential buildings.

In addition, the building may be a multi-story building having a plurality of floors or, conversely, a single-story building.

However, in the present disclosure, for convenience of description, infrastructure or facility infrastructure applied to a multi-story building will be described as an example.

In the present disclosure, infrastructure or facility infrastructure is a facility provided in a building for service provision, movement of robots, maintenance of functions, maintenance of cleanliness, and the like, and the types and forms thereof may vary widely.

For example, the infrastructure provided in a building may vary, such as movement facilities (e.g., robot movement passages, elevators, escalators, etc.), charging facilities, communication facilities, cleaning facilities, structures (e.g., stairs, etc.), and the like.

In the present specification, such facilities are referred to as facilities, infrastructure, facility infrastructure, or facility infrastructure, and the terms may be used interchangeably depending on the context.

Furthermore, in the building according to the present disclosure, at least one of the building, various facility infrastructure provided in the building, and robots may be controlled in conjunction with each other, so that the robots can safely and accurately provide various services within the building.

The present disclosure proposes a building equipped with various facility infrastructure capable of supporting a plurality of robots traveling within the building, providing services according to tasks (or work), and supporting standby or charging functions as needed, and furthermore, repair and cleaning functions for the robots.

Such a building provides an integrated solution (or system) for robots, and the building according to the present disclosure may be named with various modifiers.

For example, the building according to the present disclosure may be expressed in various ways, such as (i) a building equipped with infrastructure used by robots, (ii) a building equipped with robot-compatible infrastructure, (iii) a robot-compatible building, (iv) a building where robots and people live together, and (v) a building providing various services using robots.

In the present disclosure, the meaning of “robot-compatible” refers to a building in which robots coexist, and more specifically, may mean that the building allows robots to travel, that robots provide services, that facility infrastructure usable by robots is established, or that facility infrastructure providing functions necessary for robots (e.g., charging, repair, cleaning, etc.) is established.

In this case, “robot-compatible” in the present disclosure may be used to mean that an integrated solution for the coexistence of robots and people is provided.

Hereinafter, the present disclosure will be examined in more detail together with the accompanying drawings.

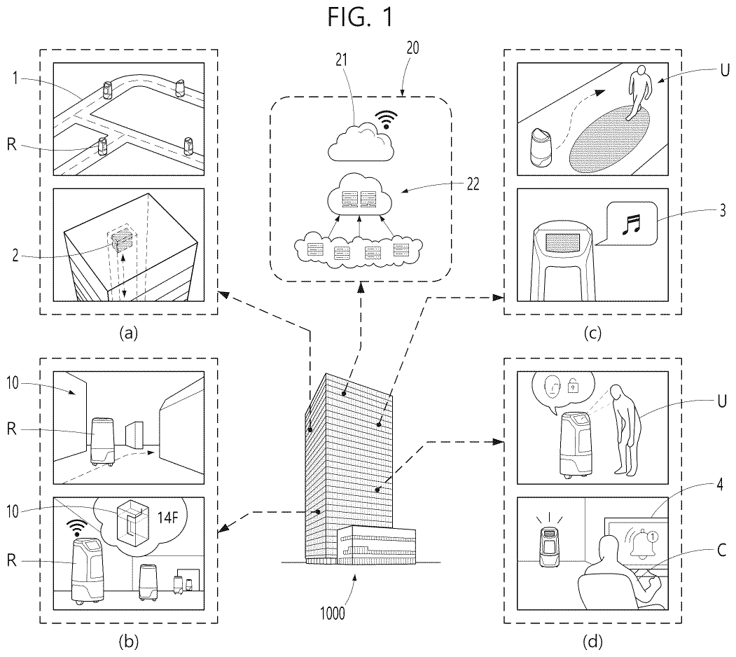

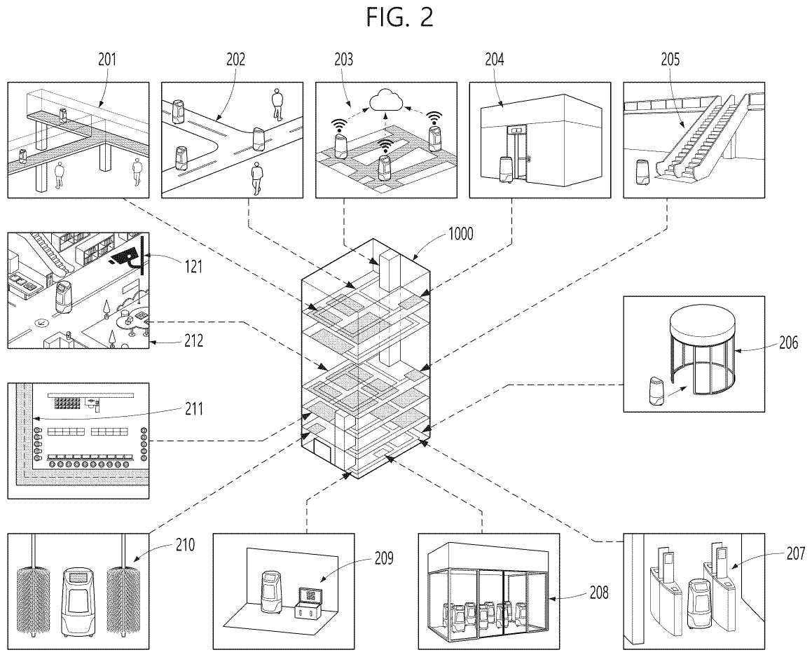

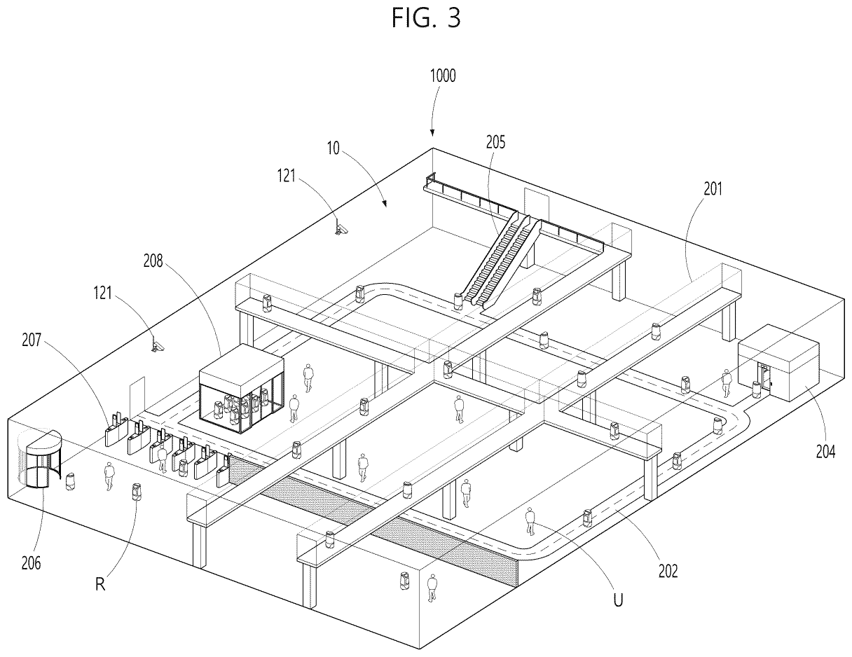

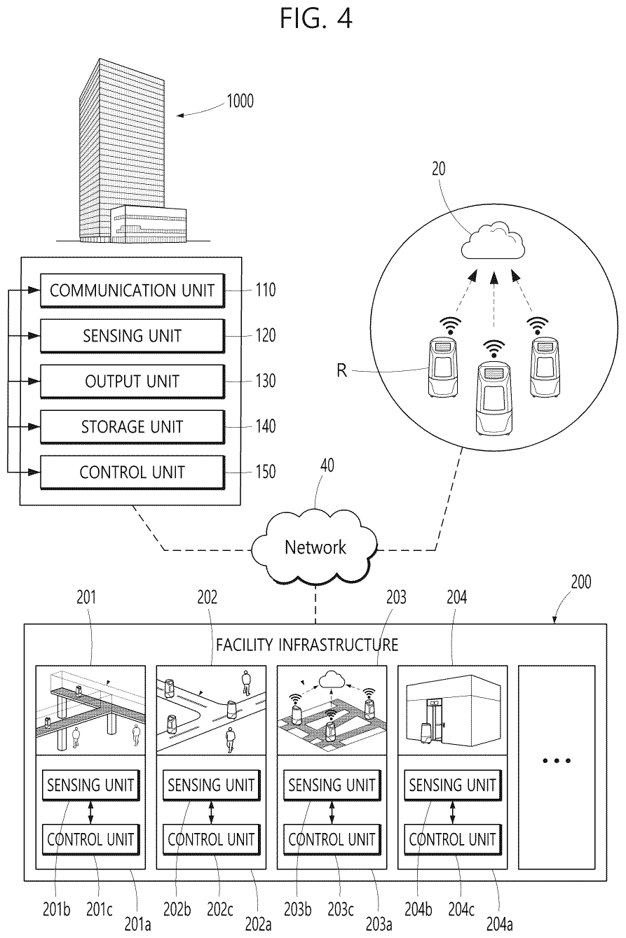

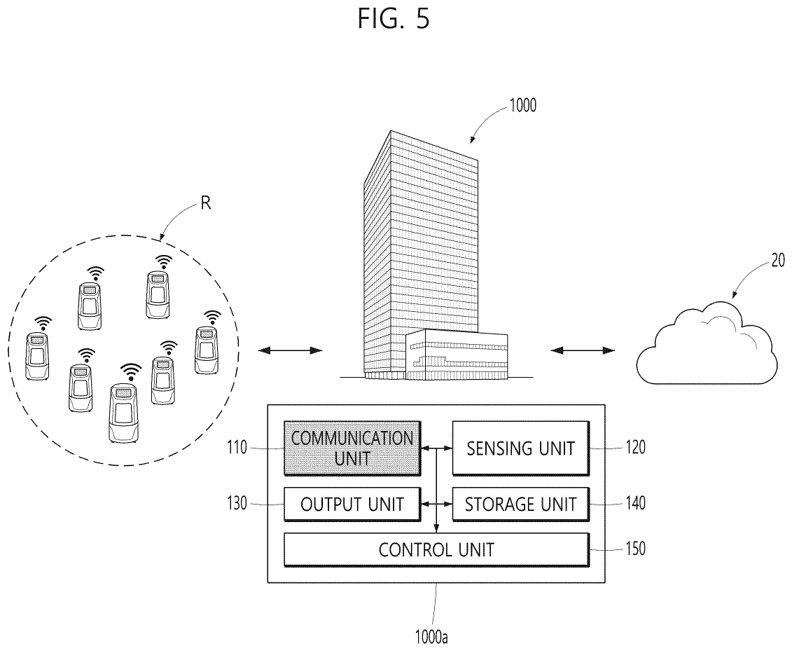

FIGS. 1, 2, and 3 are conceptual diagrams for explaining a robot-compatible building according to the present disclosure, and FIGS. 4, 5, and 6 are conceptual diagrams for explaining a system for controlling a robot traveling in a robot-compatible building according to the present disclosure and various facilities provided in the robot-compatible building.

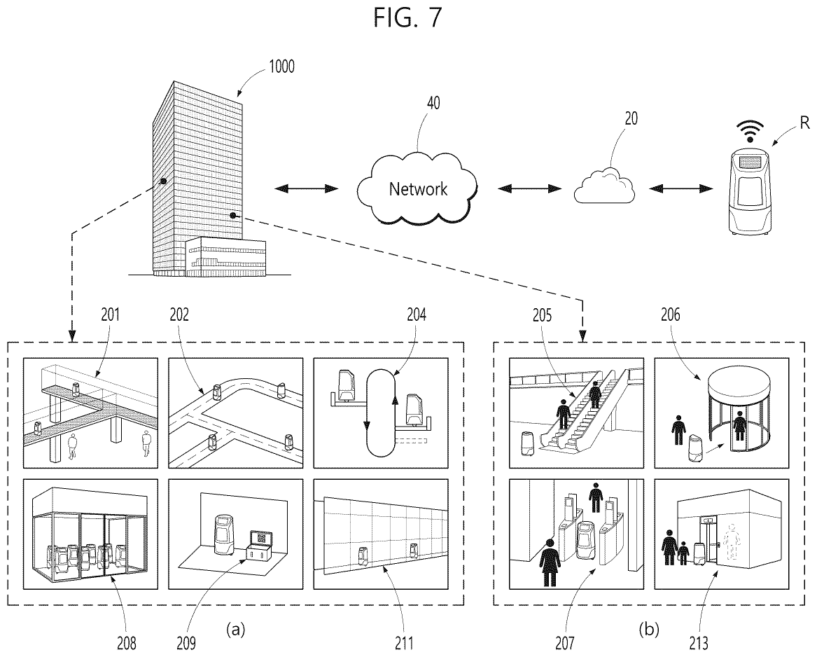

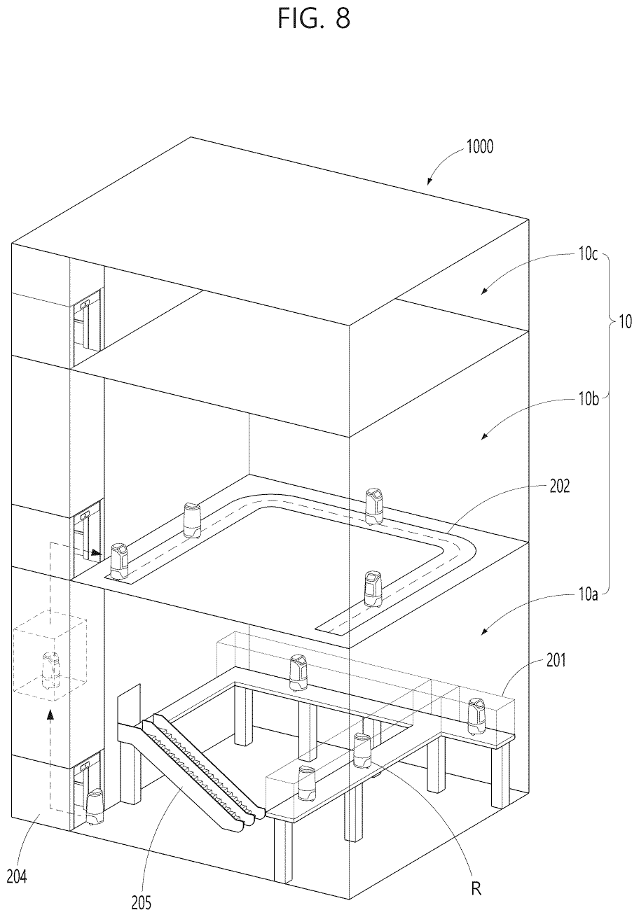

Furthermore, FIGS. 7 and 8 are conceptual diagrams for explaining facility infrastructure provided in a robot-compatible building according to the present disclosure.

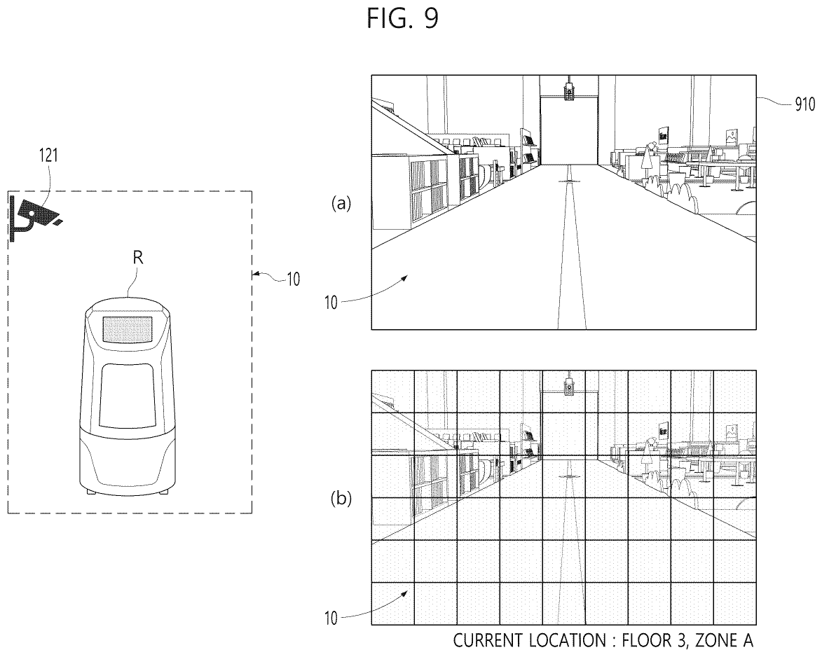

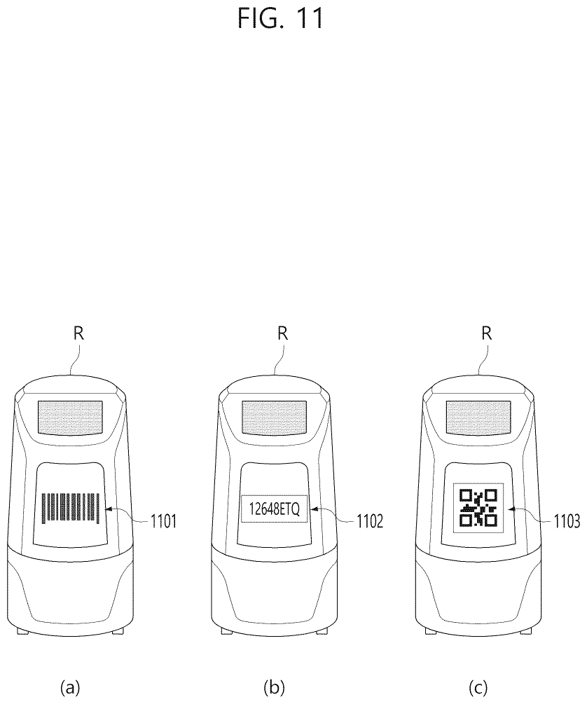

FIGS. 9 to 11 are conceptual diagrams for explaining a method of estimating a location of a robot traveling in a robot-compatible building according to the present disclosure.

First, for convenience of description, representative reference numerals will be defined.

In the present disclosure, a building is assigned reference numeral “1000”, and a space (indoor space or indoor area) of the building 1000 is assigned reference numeral “10” (see FIG. 8).

Furthermore, indoor spaces corresponding to a plurality of floors constituting the indoor space of the building 1000 are assigned reference numerals 10a, 10b, 10c, and the like (see FIG. 8).

In the present disclosure, an indoor space or indoor area refers to the interior of a building protected by an outer wall as a concept opposite to the exterior of the building, and is not limited to meaning only a space.

Furthermore, in the present disclosure, a robot is assigned reference numeral “R”, and even if a reference numeral is not indicated for a robot in the drawings or the specification, all robots may be understood as robot R.

Furthermore, in the present disclosure, a person or human is assigned reference numeral “U”, and a person or human may be named as a dynamic object.

In this case, a dynamic object does not necessarily mean only a person, but may be understood to include movable objects such as animals like dogs and cats, at least one other robot (e.g., a user's personal robot, a robot providing another service, etc.), a drone, and a cleaner (e.g., a robot vacuum cleaner).

The building (i.e., a building, structure, or edifice) 1000 described in the present disclosure is not limited to a particular type, and may refer to a structure built for people to live in, work in, raise animals in, or store goods.

For example, the building 1000 may be an office, an office building, an officetel, an apartment, a mixed-use residential apartment, a house, a school, a hospital, a restaurant, a government office, and the like, and the present disclosure may be applied to these various types of buildings.

As shown in FIG. 1, in the building 1000 according to the present disclosure, robots may travel and provide various services.

One or more different types of robots may be located within the building 1000, and these robots may travel within the building 1000, provide services, and use various facility infrastructure provided in the building 1000 under the control of a server 20.

In the present disclosure, the location of the server 20 may vary.

For example, the server 20 may be located at least one of inside the building 1000 and outside the building 1000.

That is, at least a part of the server 20 may be located inside the building 1000, and the remaining part may be located outside the building 1000.

Alternatively, the server 20 may be located entirely inside the building 1000, or may be located only outside the building 1000.

Accordingly, in the present disclosure, no particular limitation is placed on the specific location of the server 20.

Furthermore, in the present disclosure, the server 20 may be configured to use at least one of a cloud computing-type server (cloud server) 21 and an edge computing-type server (edge server) 22.

Furthermore, the server 20 may be applied to the present disclosure as long as it is capable of controlling robots, in addition to cloud computing or edge computing methods.

The server 20 according to the present disclosure may, in some cases, perform control of at least one of robots and facility infrastructure provided in the building 1000 by combining a cloud computing-type server 21 and an edge computing-type server.

The robot R may be driven according to a control command.

For example, the robot R may move its position or change its posture by changing its movement, and may perform software updates.

In the present disclosure, for convenience of description, the server 20 is uniformly referred to as a “cloud server” and is assigned reference numeral “20”.

It will be appreciated that such a cloud server 20 may also be referred to as the edge server 22 of edge computing.

Furthermore, the term “cloud server” may be variously changed to terms such as cloud robot system, cloud system, cloud robot control system, and cloud control system.

The cloud server 20 according to the present disclosure is capable of performing integrated control of a plurality of robots traveling in the building 1000.

That is, the cloud server 20 may (i) perform monitoring of a plurality of robots R located within the building 1000, (ii) assign tasks (or work) to the plurality of robots, (iii) directly control facility infrastructure provided in the building 1000 so that the plurality of robots R successfully perform their tasks, or (iv) allow the facility infrastructure to be controlled through communication with a control system that controls the facility infrastructure.

Furthermore, the cloud server 20 may check status information of robots located in the building and provide (or support) various functions necessary for the robots.

Here, the various functions may include a charging function for the robots, a cleaning function for contaminated robots, a standby function for robots that have completed their tasks, and the like.

The cloud server 20 may control the robots so that the robots use various facility infrastructure provided in the building 1000, in order to provide various functions for the robots.

Furthermore, the cloud server may directly control facility infrastructure provided in the building 1000, or allow the facility infrastructure to be controlled through communication with a control system that controls the facility infrastructure, in order to provide various functions for the robots.

In this way, robots controlled by the cloud server 20 may travel in the building 1000 and provide various services.

The cloud server 20 may perform various controls based on information stored in a database, and in the present disclosure, no particular limitation is placed on the type and location of the database.

The term “database” may be freely modified and used as any term that refers to a means of storing information, such as memory, storage unit, storage, cloud storage, external storage, external server, and the like.

Hereinafter, the description will be unified using the term “database”.

The cloud server 20 according to the present disclosure may perform distributed control of robots based on various criteria such as the types of services provided by the robots and the types of control for the robots, and in this case, the cloud server 20 may have subordinate sub-servers of a lower-level concept.

Furthermore, the cloud server 20 according to the present disclosure may control robots traveling in the building 1000 based on various artificial intelligence algorithms.

Furthermore, the cloud server 20 performs artificial intelligence-based learning that utilizes data collected in the process of controlling robots as learning data and applies it to the control of robots, so that the more control is performed on the robots, the more accurately and efficiently the robots can be operated.

That is, the cloud server 20 may be configured to perform deep learning or machine learning.

In addition, the cloud server 20 may perform deep learning or machine learning through simulation and the like, and may perform control of robots using an artificial intelligence model constructed as a result.

The building 1000 may be equipped with various facility infrastructure for robot travel, provision of robot functions, maintenance of robot functions, performance of robot tasks, or coexistence of robots and people.

For example, as shown in FIG. 1(a), various facility infrastructure 1, 2 capable of supporting traveling (or movement) of the robot R may be provided within the building 1000.

Such facility infrastructure 1, 2 may support horizontal movement of the robot R within a floor of the building 1000, or may support vertical movement so that the robot R moves between different floors of the building 1000.

In this way, the facility infrastructure 1, 2 may include a transportation system that supports movement of the robot.

The cloud server 20 may control the robot R to use such various facility infrastructure 1, 2, so that the robot R moves within the building 1000 to provide services, as shown in FIG. 1(b).

Robots according to the present disclosure may be controlled based on at least one of the cloud server 20 and a control unit provided in the robot itself, so as to travel within the building 1000 or provide a service corresponding to an assigned task.

Furthermore, as shown in FIG. 1(c), the building according to the present disclosure is a building in which robots and people coexist, and the robots are configured to travel while avoiding obstacles such as people U, objects used by people (e.g., strollers, carts, etc.), and animals, and may be configured to output notification information 3 related to the traveling of the robot in some cases.

Such traveling of the robot may be configured to avoid obstacles based on at least one of the cloud server 20 and a control unit provided in the robot.

The cloud server 20 may perform control of the robot so that the robot moves within the building 1000 while avoiding obstacles, based on information received through various sensors provided in the robot (e.g., a camera (image sensor), a proximity sensor, an infrared sensor, etc.).

In addition, a robot traveling within the building through the processes of FIG. 1(a) to 1(c) may be configured to provide a service to a person or a target object present in the building, as shown in FIG. 1(d).

The types of services provided by the robot may differ for each robot.

That is, various types of robots may exist depending on the purpose, and robots may have different structures for each purpose, and robots may be equipped with programs suitable for their purpose.

For example, robots that provide at least one service among delivery, logistics work, guidance, interpretation, parking support, security, crime prevention, guard, public safety, cleaning, quarantine, disinfection, laundry, beverage preparation, food preparation, serving, firefighting, medical support, and entertainment services may be deployed in the building 1000.

The services provided by robots may vary beyond the examples listed above.

The cloud server 20 may assign appropriate tasks to the robots in consideration of the purpose of each robot, and may perform control of the robots so that the assigned tasks are carried out.

At least some of the robots described in the present disclosure may travel or perform tasks under the control of the cloud server 20, and in this case, the amount of data processed by the robot itself to perform traveling or tasks may be minimized.

In the present disclosure, such a robot may be referred to as a brainless robot.

Such a brainless robot may rely on the control of the cloud server 20 for at least some control in performing actions such as traveling, performing tasks, charging, standby, and cleaning within the building 1000.

However, in the present specification, brainless robots are not distinguished and separately named, but are all uniformly referred to as “robots”.

Hereinafter, with reference to the contents of the building 1000, the building system 1000a, the facility infrastructure 200, and the cloud server 20 described above, the process by which the robot R uses the facility infrastructure 200 will be examined in more detail.

In this case, the robot R may travel through the indoor space 10 of the building 1000 or move using the facility infrastructure 200, and furthermore, may use the facility infrastructure 200, for purposes such as performing tasks (or providing services), traveling, charging, maintaining cleanliness, and standby.

In this way, the robot R may travel through the indoor space of the building 1000 or move using the facility infrastructure 200, and furthermore, may use the facility infrastructure 200, based on a certain “purpose” in order to achieve the “purpose”.

In this case, the purpose to be achieved by the robot may be identified based on various causes.

The purpose to be achieved by the robot may include a first type of purpose and a second type of purpose.

Here, the first type of purpose may be for the robot to perform its inherent task, and the second type of purpose may be for the robot to perform a task or function other than the robot's inherent task.

That is, the purpose to be achieved by the robot according to the first type may be a purpose for performing the robot's inherent task.

Such a purpose may also be understood as a “task” of the robot.

For example, when the robot is a robot that provides a serving service, the robot may travel through the indoor space of the building 1000 or move using the facility infrastructure 200, and furthermore, may use the facility infrastructure 200, in order to achieve the purpose or task of providing the serving service.

In addition, when the robot is a robot that provides a navigation service, the robot may travel through the indoor space of the building 1000 or move using the facility infrastructure 200, and furthermore, may use the facility infrastructure 200, in order to achieve the purpose or task of providing the navigation service.

A plurality of robots operated according to different purposes may be located in the building according to the present disclosure.

That is, different robots capable of performing different tasks may be deployed in the building, and different types of robots may be deployed in the building according to the needs of the building manager and various entities that have moved into the building.

For example, robots that provide at least one service among delivery, logistics work, guidance, interpretation, parking support, security, crime prevention, guard, public safety, cleaning, quarantine, disinfection, laundry, beverage preparation, food preparation, serving, firefighting, medical support, and entertainment services may be deployed in the building.

The services provided by robots may vary beyond the examples listed above.

The second type of purpose is for the robot to perform a task or function other than the robot's inherent task, and this may be a purpose unrelated to the robot's inherent task.

Such a second type of purpose may be a task or function that is not directly related to the robot performing its inherent task, but is indirectly necessary.

For example, in order for the robot to perform its inherent task, sufficient power necessary for operation is required, and in order for the robot to provide comfortable services to people, cleanliness must be maintained.

Furthermore, in order for a plurality of robots to be efficiently operated within a building, there may be situations where the robots are on standby in a certain space at times.

In this way, in the present disclosure, the robot may travel through the indoor space of the building 1000 or move using the facility infrastructure 200, and furthermore, may use the facility infrastructure 200, in order to achieve the second type of purpose.

For example, the robot may use charging facility infrastructure to achieve the purpose according to a charging function, and may use cleaning facility infrastructure to achieve the purpose according to a cleaning function.

In this way, in the present disclosure, the robot may travel through the indoor space of the building 1000 or move using the facility infrastructure 200, and furthermore, may use the facility infrastructure 200, in order to achieve a certain purpose.

The cloud server 20 may perform appropriate control of each of the robots located within the building, based on information corresponding to each of a plurality of robots located in the building stored in a database.

Various information on each of a plurality of robots located within the building may be stored in the database, and information on the robot R may vary widely.

As an example, there may exist: (i) identification information for identifying the robot R deployed in the space 10 (e.g., serial number, TAG information, QR code information, etc.), (ii) task information assigned to the robot R (e.g., type of task, operation according to the task, target user information that is the subject of the task, task execution location, scheduled task execution time, etc.), (iii) travel path information set for the robot R, (iv) location information (or position information) of the robot R, (v) status information of the robot R (e.g., power status, presence of malfunction, cleaning status, battery status, etc.), (vi) image information received from a camera provided in the robot R, and (vii) operation information related to the operation of the robot R.

Appropriate control of the robots may be related to control for operating the robots according to the first type of purpose or the second type of purpose discussed above.

Here, operation of the robot may refer to control that causes the robot to travel through the indoor space of the building 1000 or move using the facility infrastructure 200, and furthermore, to use the facility infrastructure 200.

Movement of the robot may be referred to as traveling of the robot, and therefore, in the present disclosure, travel path and driving path may be used interchangeably.

The cloud server 20 may assign appropriate tasks to the robots according to the purpose (or inherent task) of each robot, and may perform control of the robots so that the assigned tasks are carried out, based on information on each robot stored in the database.

In this case, the task to be assigned may be a task for achieving the first type of purpose discussed above.

Furthermore, the cloud server 20 may perform control for achieving the second type of purpose on each of the robots, based on information on each robot stored in the database.

In this case, a robot that has received a control command for achieving the second type of purpose from the cloud server 20 may move to charging facility infrastructure or cleaning facility infrastructure, and the like, based on the control command, to achieve the second type of purpose.

Hereinafter, the terms “purpose” or “task” will be used without distinguishing between the first type and the second type of purpose.

The purpose described hereinafter may be either the first type of purpose or the second type of purpose.

Likewise, a task described hereinafter may also be either a task for achieving the first type of purpose or a task for achieving the second type of purpose.

For example, when a robot capable of providing a serving service exists and a target to be served (a target user) exists, the cloud server 20 may perform control of the robot so that the robot performs a task corresponding to serving for the target user.

As another example, when a robot in need of charging exists, the cloud server 20 may perform control to cause the robot to move to charging facility infrastructure so that the robot performs a task corresponding to charging.

Accordingly, hereinafter, a method by which the robot performs a purpose or task using the facility infrastructure 200 under the control of the cloud server 20, without distinction between the first type of purpose and the second type of purpose, will be examined in more detail.

In the present specification, it is also possible that a robot controlled by the cloud server 20 to perform a task is referred to as a “target robot”.

The cloud server 20 may identify at least one robot to perform a task based on a request or its own judgment.

Here, the request may be received from various entities.

For example, the cloud server may receive requests from various entities such as visitors, managers, residents, and workers located in the building, in various ways (e.g., user input through an electronic device, gesture-based user input).

Here, the request may be a service request for a specific service (or a specific task) to be provided by the robot.

Based on such a request, the cloud server 20 may identify a robot capable of performing the corresponding service among a plurality of robots located within the building 1000.

The cloud server 20 may identify a robot capable of responding to the request based on (i) the types of services that the robot can perform, (ii) the task previously assigned to the robot, (iii) the current location of the robot, and (iv) the status of the robot (e.g., power status, cleanliness status, battery status, etc.).

As examined above, various information on each robot exists in the database, and the cloud server 20 may identify a robot to perform a task based on the request, based on this database.

Furthermore, the cloud server 20 may identify at least one robot to perform a task based on its own judgment.

Here, the cloud server 20 may perform its own judgment based on various causes.

As an example, the cloud server 20 may determine whether a service needs to be provided to a specific user or a specific space existing within the building 1000.

The cloud server 20 may extract a specific target requiring service provision, based on information sensed and received from at least one of a sensing unit (120, see FIGS. 4 to 6) existing in the building 1000, a sensing unit included in the facility infrastructure 200, and a sensing unit provided in the robot.

Here, the specific target may include at least one of a person, a space, or an object.

An object may mean a facility, an article, or the like located within the building 1000.

In addition, the cloud server 20 may identify the type of service required for the extracted specific target and control the robot so that the specific service is provided to the specific target.

To this end, the cloud server 20 may identify at least one robot to provide a specific service to the specific target.

The cloud server 20 may determine a target requiring service provision based on various determination algorithms.

For example, the cloud server 20 may identify a type of service, such as navigation, serving, stair movement, and the like, based on information sensed and received from at least one of a sensing unit (120, see FIGS. 4 to 6) existing in the building 1000, a sensing unit included in the facility infrastructure 200, and a sensing unit provided in the robot.

In addition, the cloud server 20 may identify a target requiring the corresponding service.

Furthermore, the cloud server 20 may identify a robot capable of providing the identified service, so that the service is provided by the robot.

Furthermore, the cloud server 20 may determine a specific space requiring service provision based on various determination algorithms.

For example, the cloud server 20 may extract a specific space or object requiring service provision, such as a target user for delivery, a guest requiring guidance, a contaminated space, a contaminated facility, a fire zone, and the like, based on information sensed and received from at least one of a sensing unit (120, see FIGS. 4 to 6) existing in the building 1000, a sensing unit included in the facility infrastructure 200, and a sensing unit provided in the robot, and may identify a robot capable of providing the corresponding service so that a service by the robot is provided to the specific space or object.

In this way, when a robot to perform a specific task (or service) is identified, the cloud server 20 may assign a task to the robot and perform a series of controls necessary for the robot to perform the task.

In this case, the series of controls may include at least one of (i) setting a travel path of the robot, (ii) identifying facility infrastructure to be used for moving to a destination where a task is to be performed, (iii) communication with the identified facility infrastructure, (iv) control of the identified facility infrastructure, (v) monitoring the robot performing the task, (vi) evaluation of the robot's traveling, and (vii) monitoring whether the robot has completed the task.

The cloud server 20 may identify a destination at which the robot's task is to be performed and set a travel path for the robot to reach the destination.

The robot R may be controlled to move to the corresponding destination for performing a task when a travel path is set by the cloud server 20.

The cloud server 20 may set a travel path for reaching from a location where the robot starts (initiates) performing a task (hereinafter referred to as “task performance start location”) to a destination.

Here, the location at which the robot starts performing a task may be the current location of the robot, or the location of the robot at the point in time when the robot starts performing the task.

The cloud server 20 may generate a travel path of the robot to perform a task, based on a map (or map information) corresponding to the indoor space 10 of the building 1000.

Here, the map may include map information on a space of each of a plurality of floors (10a, 10b, 10c, . . . ) constituting the indoor space of the building.

Furthermore, the travel path may be a travel path from the task performance start location to a destination where the task is performed.

In the present disclosure, such map information and travel path are described as being for an indoor space, but the present disclosure is not necessarily limited thereto.

For example, the map information may include information on an outdoor space, and the travel path may be a path extending from an indoor space to an outdoor space.

The present disclosure relates to a method and system for controlling a robot traveling in a building based on a node map including a plurality of nodes, and may control various behaviors (e.g., Sound On/Off, Light On/Off, rotation, and interactions with a user (e.g., greeting, knock)) based on the current location of the robot while traveling.

Hereinafter, a method for controlling a behavior of the robot based on the location of the robot will be described in more detail with reference to the accompanying drawings.

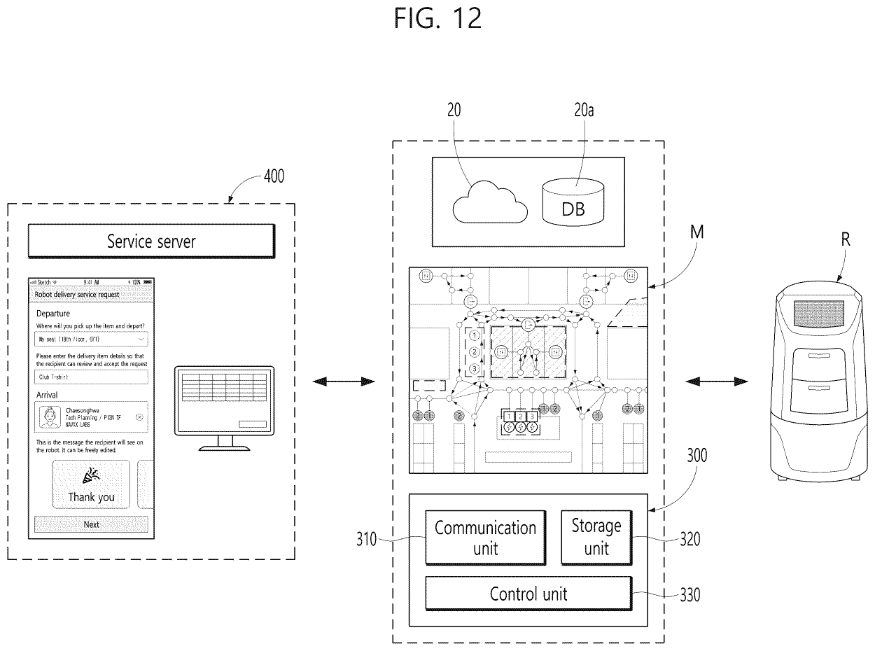

FIG. 12 is a conceptual diagram for explaining a robot control system according to the present disclosure.

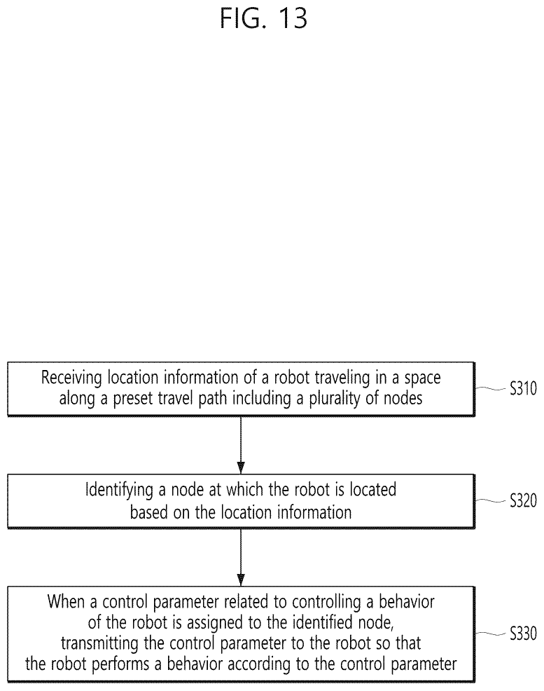

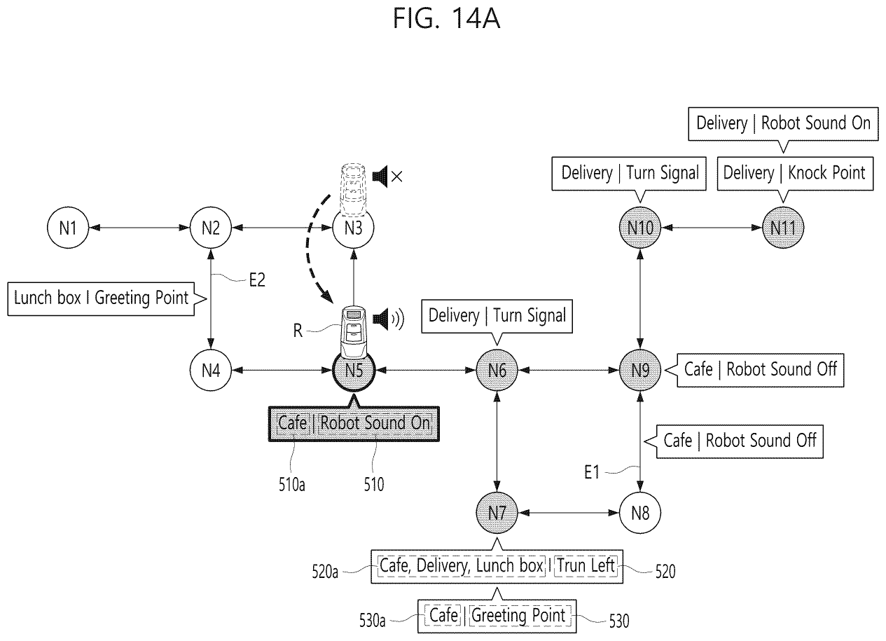

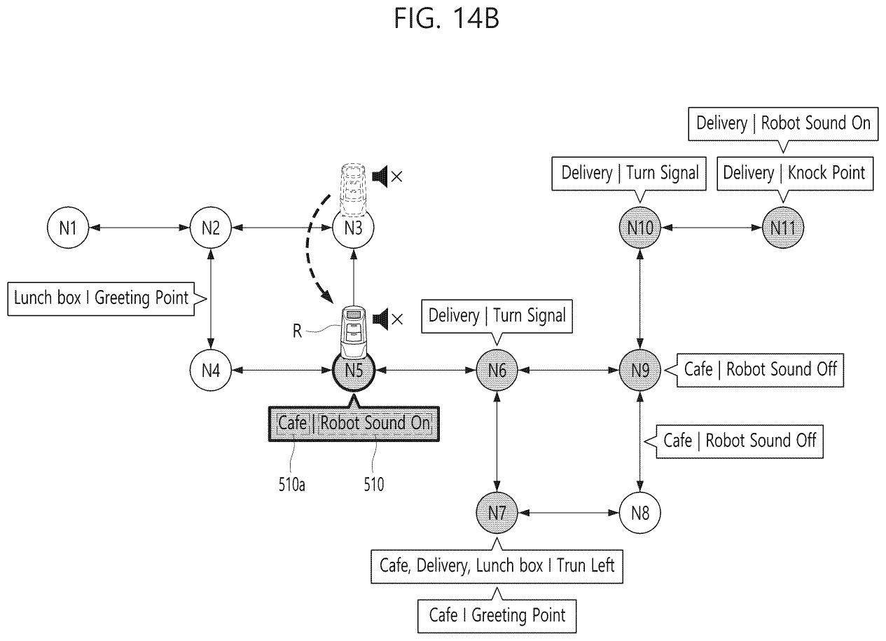

FIG. 13 is a flowchart for explaining a method for controlling a robot according to the present disclosure, and FIGS. 14a, 14b, 15, 16, 17, 18a, 18b, 19, and 20 are conceptual diagrams for explaining a method for controlling a behavior of the robot according to the location of the robot using a node map.

As shown in FIG. 12, the robot control system 300 according to the present disclosure may be configured to include at least one of a communication unit 310, a storage unit 320, and a control unit 330.

The communication unit 310 may be configured to communicate by wire or wirelessly with various devices disposed in the space 10.

The communication unit 310 may communicate with the robot R as shown.

The communication unit 310 may be configured to transmit a control command for controlling the robot R to the robot R through communication with the robot R.

Furthermore, the communication unit 310 may be configured to receive a robot service request from at least one service server (or external server) 400.

Here, the service server 400 is a server that provides robot services (e.g., order service, delivery service, courier service, etc.) in conjunction with the robot control system 300, and may perform a series of data processing (e.g., order reception, robot task identification, etc.) according to the scenario of each service.

For example, the service server 400 may include a customer system, an operator system, a robot service system, a courier system, an order system, a delivery system, a guidance system, a secretary system, a café system, a lunch box system, and the like.

The communication unit 310 may support various communication methods according to the communication standard of the device with which it communicates.

For example, the communication unit 310 may be configured to communicate with devices (including cloud servers) located inside and outside the space 10 using at least one of WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), 5G (5 th Generation Mobile Telecommunication), Bluetooth™, RFID (Radio Frequency Identification), IrDA (Infrared Data Association), UWB (Ultra-Wideband), ZigBee, NFC (Near Field Communication), Wi-Fi Direct, and Wireless USB (Wireless Universal Serial Bus) technologies.

Next, the storage unit 320 may be configured to store various information related to the present disclosure.

In the present disclosure, the storage unit 320 may be provided in the robot control system 300 itself.

Alternatively, at least a part of the storage unit 320 may refer to at least one of the cloud server 20 and the database 20a.

That is, it may be understood that the storage unit 320 merely needs to be a space in which information necessary for robot control according to the present disclosure is stored, and there is no restriction on the physical space.

Accordingly, hereinafter, the storage unit 320, the cloud server 20, and the database 20a will not be separately distinguished and will all be expressed as the storage unit 320.

In this case, the cloud server 20 may refer to “cloud storage”.

Information on the robot R may be stored in the storage unit 320.

The information on the robot R may be very diverse, and examples of the information on the robot R may include (i) identification information for identifying the robot R disposed in the space 10 (e.g., serial number, TAG information, QR code information, etc.), (ii) task information assigned to the robot R, (iii) travel path (or driving path) information set for the robot R, (iv) location information of the robot R, (v) status information of the robot R (e.g., power status, whether a malfunction exists, battery status, etc.), and (vi) image information received from a camera provided in the robot R.

A map (or map information) of the space 10 may be stored in the storage unit 320.

The map of the space 10 may refer to a map that can be utilized to identify the current location of the robot R or to set a travel path of the robot.

The map information stored in the storage unit 320 may correspond to a node map M including a plurality of nodes.

In the storage unit 320, a specific node, a control parameter assigned to the specific node, and a service code dependent on the control parameter may exist in a matched manner.

Such matching information may also be described as being included in the node map M.

Here, “control parameter” may refer to information (or a control command) related to behavior control of the robot R.

More specifically, the control parameter may be understood as information for controlling the behavior of the robot R to be performed through control of at least a part of the components of the robot R (e.g., an acoustic output unit, a display unit, a driving unit, a lighting unit, a storage compartment, etc.).

For example, the control parameter may be predefined as “Robot Sound On (sound activation or acoustic output unit activation)”, “Robot Sound Off (sound deactivation or acoustic output unit deactivation)”, “Turn Left (rotate to the left)”, “Turn Right (rotate to the right)”, “Turn Signal (signal activation or lighting unit activation)”, “Greeting Point (perform greeting interaction, for example, outputting greeting information ”Hello“ through the display unit or acoustic output unit of the robot)”, and “Knock Point (perform knock interaction, for example, outputting a knock sound ”Knock Knock“ through the acoustic output unit of the robot)”.

Furthermore, a “service code” dependent on the control parameter is information for identifying the robot R to be controlled according to the control parameter, and the robot R to which a task corresponding to the service code is assigned may be identified as the target robot R to be controlled according to the control parameter.

For example, if the service code matched to “Robot Sound On (sound activation)” is “café service”, in the present disclosure, the robot R performing a task corresponding to “Robot Sound On (sound activation)” and “café service” may be identified as the robot R to be controlled by the control parameter.

Next, the control unit 330 may be configured to control the overall operation of the robot control system 300 related to the present disclosure.

The control unit 330 may control the traveling and behavior (operation) of the robot R by processing signals, data, information, and the like that are input or output through the components described above.

In the present disclosure, the control unit 330 may be used interchangeably with the cloud server 20.

As described above, the cloud server 20 may perform integrated control over a plurality of robots R traveling in the building 1000.

The cloud server 20 may (i) monitor a plurality of robots R located in the building 1000, (ii) assign tasks (or duties) to the plurality of robots, and (iii) control the traveling and behavior (operation) of the robots R so that the plurality of robots R successfully perform their tasks.

Accordingly, the robot control system 300 according to the present disclosure may be understood as a part of the cloud server 20, and in particular, the robot control system 300 may be understood as having data processing performed under the control of the cloud server 20.

The control unit 330 may use the node map M to generate a travel path from a node corresponding to the current location of the robot R to another node corresponding to a destination.

More specifically, the control unit 330 may identify at least one waypoint node through which the robot R must pass in order to reach a destination for performing a task.

The control unit 330 may generate a travel path by connecting a departure node, waypoint nodes, and a destination node.

The control unit 330 may transmit a control command to the robot R so that the robot R travels according to the generated travel path.

The control unit 330 may control the robot R so that the robot R traveling along the travel path performs a behavior according to a control parameter assigned to a node, based on the robot R being located at a node to which a control parameter is assigned among the plurality of nodes.

That is, the control unit 330 may additionally and in parallel (simultaneously) perform behavior control of the robot R according to the control parameter when the robot R is located at a node to which a control parameter is assigned, while controlling the traveling of the robot R so that the robot R travels from a departure node (or departure point) to a destination node (or destination).

Hereinafter, a method for additionally controlling a behavior of the traveling robot R will be described in more detail.

In the present disclosure, a process of receiving location information of a robot traveling in a space along a preset travel path including a plurality of nodes may be performed (S310, see FIG. 13).

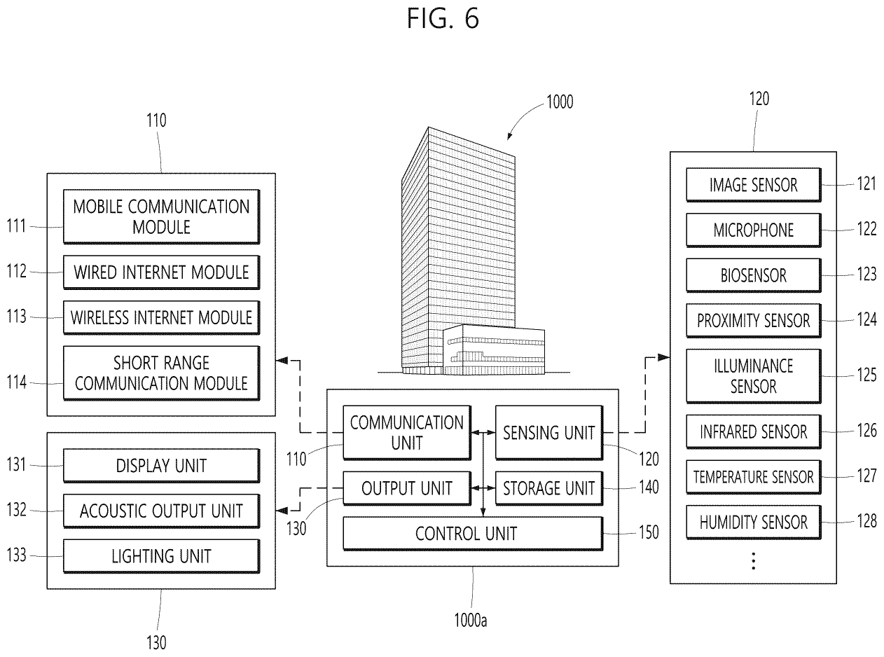

The control unit 330 may receive location information of the robot R from any one of (i) the robot R, (ii) a sensing unit (120, see FIG. 6) provided in the building 1000, and (iii) sensing units (201b, 202b, 203b, 204b, see FIG. 4) provided in facilities.

The control unit 330 may obtain current location information of the robot R from any one or a combination of at least two of (i) to (iii) above.

More specifically, the control unit 330 may receive real-time location information of the robot R from the robot R.

In this case, the location information is information including the current location of the robot R, and may correspond not only to information in which the current location of the robot R is directly identified, but also to various information used to identify the current location of the robot R.

As an example, as shown in FIG. 9, the control unit 330 according to the present disclosure may be configured to receive an image of the space 10 using a camera (not shown) provided in the robot R, and to perform Visual Localization for estimating the location of the robot from the received image.

In this case, the camera is configured to capture (or sense) an image of the space 10, that is, an image of the surroundings of the robot R.

Hereinafter, for convenience of explanation, an image obtained using a camera provided in the robot R will be referred to as a “robot image”.

In addition, an image obtained through a camera disposed in the space 10 will be referred to as a “space image”.

The control unit 330 is configured to obtain a robot image 910 through a camera (not shown) provided in the robot R, as shown in FIG. 9(a).

In addition, the control unit 330 may estimate the current location of the robot R using the obtained robot image 910.

The control unit 330 may compare the robot image 910 with map information stored in a database to extract location information corresponding to the current location of the robot R (e.g., “3rd floor, Zone A (3, 1, 1)”), as shown in FIG. 9(b).

As described above, in the present disclosure, the map of the space 10 may be a map created based on SLAM (Simultaneous Localization and Mapping) by at least one robot moving in the space 10 in advance.

In particular, the map of the space 10 may be a map generated based on image information.

That is, the map of the space 10 may be a map generated by vision (or visual)-based SLAM technology.

Accordingly, the control unit 330 may identify coordinate information (e.g., (3rd floor, Zone A (3, 1, 1))) for the robot image 910 obtained from the robot R, as shown in FIG. 9(b).

In this way, the identified coordinate information may serve as the current location information of the robot R.

In this case, the control unit 330 may estimate the current location of the robot R by comparing the robot image 910 obtained from the robot R with a map generated by vision (or visual)-based SLAM technology.

In this case, the control unit 330 may identify the location information of the robot R by (i) identifying an image most similar to the robot image 910 using image comparison between the robot image 910 and images constituting the previously generated map, and (ii) obtaining location information matched to the identified image.

In this way, as shown in FIG. 9(a), when the robot image 910 is obtained from the robot R, the control unit 330 may identify the current location of the robot using the obtained robot image 910.

As described above, the control unit 330 may extract location information (e.g., coordinate information) corresponding to the robot image 910 from map information previously stored in a database (which may also be referred to as a “reference map”).

The control unit 330 may estimate the current location of the robot R using a space image obtained from a camera 121 provided in the building 1000.

The camera 121 provided (disposed) in the building 1000 may be a CCTV (closed circuit television).

The camera 121 being disposed in the building 1000 may mean that the camera 121 is disposed in an indoor space 10 of the building 1000.

The control unit 330 may extract location information corresponding to the current location of the robot R by comparing a space image with map information stored in a database.

In this case, the control unit 330 may also take into account the placement location of the camera 121 that captured the space image.

Since the method of using the space image may be the same as the method of using the robot image described above, a detailed description thereof will be omitted.

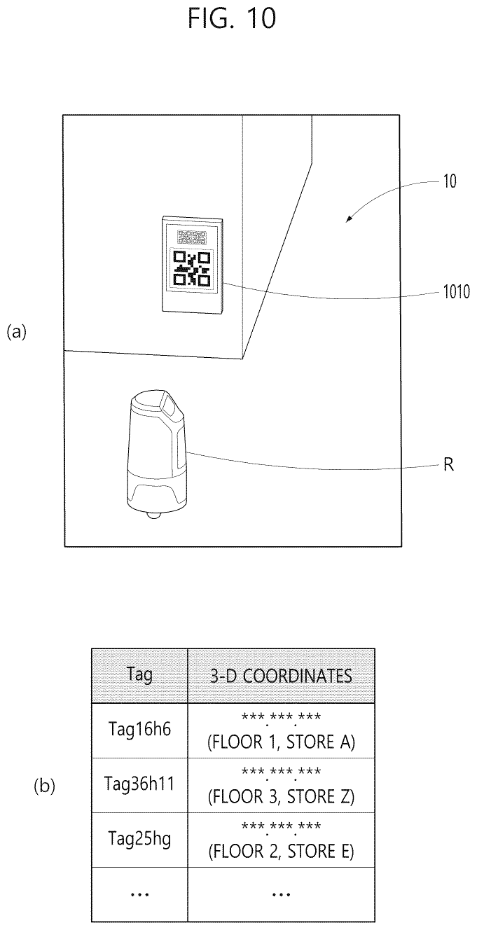

As another example, the location estimation of the robot traveling in the indoor space 10 may be performed based on a tag 1010 provided in the indoor space 10, as shown in FIG. 10(a).

Referring to FIG. 10, location information corresponding to a point at which the tag 1010 is attached may exist in a matched manner in the tag 1010, as shown in FIG. 10(b).

That is, tags 1010 having different identification information may be provided at a plurality of different points in the indoor space 10 of the building 1000, respectively.

The identification information of each tag and the location information of the point at which the tag is attached may be matched to each other and exist in a database.

Furthermore, each tag 1010 may be configured to include location information matched to the respective tag 1010.

The robot R may recognize a tag 1010 provided in the space 10 using a sensor provided in the robot R.

The control unit 330 may identify the current location of the robot R by extracting location information included in the tag 1010 received from the robot R.

The robot R may recognize a tag 1010 provided in the space 10 using a sensor provided in the robot R.

Through such recognition, the robot R or the control unit 330 may identify the current location of the robot R by extracting location information included in the tag 1010.

Accordingly, the control unit 330 of the robot control system 300 may monitor the locations of robots traveling in the building 1000 based on location information received from the robot R that sensed the tag.

The term for the tag 1010 described above may be named in various ways.

For example, such a tag 1010 may be variously referred to as a QR code, a barcode, an identification mark, or the like.

The term “tag” described above may be replaced with and used as “marker”.

In the present disclosure, a process of identifying a node at which the robot is located based on location information of the robot may be performed (S320, see FIG. 13).

As described above, the robot R may travel in the space 10 based on a node map including a plurality of nodes.

The control unit 330 may generate a travel path from the current location of the robot R to a destination using the node map, and perform driving control of the robot R so that the robot R moves according to the travel path.

As shown in FIG. 14a, the node map may include a plurality of nodes Node, N1, N2, N3 and edges Edge, E1, E2 connecting the nodes.

In the present disclosure, a ‘node’ may refer to a point or area that serves as a unit target for the movement of the robot.

An ‘edge’ may refer to information defining another node to which the robot R can move from a specific node, and may also be referred to as connection information.

A node and an edge may include specific coordinate information on a map (or space).

The control unit 330 may identify, using the location information of the robot R and the node map, which node among the plurality of nodes the robot R is located at.

There may be various methods for identifying the node at which the robot R is located.

For example, the control unit 330 may determine that the robot R is located at a specific node when the robot R is located within a preset distance (or error range) from that node.

As another example, the control unit 330 may determine the node at which the robot R is currently located by comprehensively considering the travel path of the robot R, the travel time of the robot R, and the current location information of the robot R.

In the present disclosure, the node at which the robot R is located may be identified by taking into account the fact that each robot R has a different size and that a communication delay occurs between the robot R and the system 300.

In the present disclosure, for convenience of explanation, a node identified as being where the robot R is located may be referred to as a “target node”.

In the present disclosure, when a control parameter related to behavior control of the robot is assigned to the identified node, a process of transmitting the control parameter to the robot so that the robot performs a behavior according to the control parameter may be performed (S330, see FIG. 13).

The control unit 330 may additionally and in parallel perform behavior control of the robot R so that the robot R behaves according to the control parameter, based on a control parameter being assigned to the target node at which the robot R is located, while performing driving control of the robot R so that the robot R travels along the travel path.

The “control parameter” described in the present disclosure may refer to information (or a control command) related to behavior control of the robot R.

More specifically, the control parameter may be understood as information that controls the behavior of the robot R to be performed through control of at least a part of the components of the robot R (e.g., an acoustic output unit, a display unit, a driving unit, a lighting unit, a storage compartment, etc.).

For example, control parameters may be predefined and exist as follows: “Robot Sound On (sound activation or acoustic output unit activation)”, “Robot Sound Off (sound deactivation or acoustic output unit deactivation)”, “Turn Left (rotate to the left)”, “Turn Right (rotate to the right)”, “Turn Signal (signal activation or lighting unit activation)”, “Greeting Point (perform greeting interaction)”, and “Knock Point (perform knock interaction)”.

As shown in FIG. 14a, a control parameter may be pre-assigned to at least a part N5, N6, N7, N9, N10, N11 of the plurality of nodes located in the space 10.

For example, a “Robot Sound On (sound activation)” 510 control parameter may be assigned to the “N5” node, and a “Turn Signal (signal activation)” control parameter may be assigned to the “N6” node.

The control unit 330 may check whether a control parameter is assigned to the target node at which the robot R is located.

As a result of the check, if a control parameter is assigned to the target node, the control unit 330 may transmit the control parameter to the robot R.

In this case, the control unit 330 may control the robot R so that the robot R performs a behavior according to the control parameter simultaneously with traveling.

For example, as shown in FIG. 14a, when the traveling robot R is located at the “N5” node, the control unit 330 may control the robot R to perform the “Robot Sound On (sound activation)” 510 behavior while traveling.

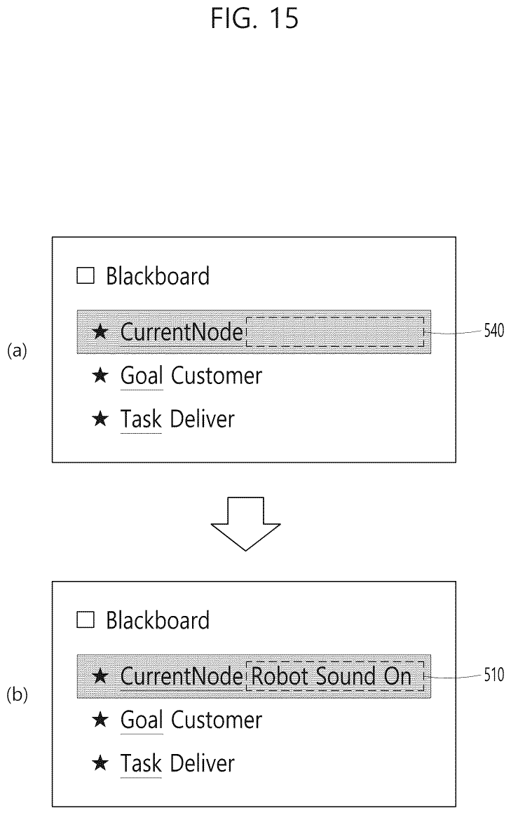

For example, as shown in FIG. 15(a), when the variable value corresponding to the current node (CurrentNode) of the robot R is “null” and the robot R is located at a node (e.g., “N5”) to which the control parameter “Robot Sound On (sound activation)” 510 is assigned, the control unit 330 may input “Robot Sound On (sound activation)” 510 into the variable value of the current node (CurrentNode) of the robot R.

The robot R may perform a behavior of activating the sound according to the input variable value based on “Robot Sound On (sound activation)” 510 being input into the variable value of the current node (CurrentNode).

The robot may continue to travel along the preset travel path while performing a behavior according to the control parameter.

On the other hand, if a control parameter is not assigned to the target node at which the robot R is located (i.e., unassigned), the control unit 330 may not perform behavior control of the robot R and may continuously perform only driving control.

When a control parameter is assigned to the target node at which the robot R is located, the control unit 330 may transmit the target control parameter to the robot R based on the robot R corresponding to the target robot to be controlled according to the corresponding control parameter (hereinafter referred to as a “target control parameter”).

The control unit 330 may determine whether the robot R is the target robot to be controlled according to the target control parameter based on a service code matched to the target control parameter and task information assigned to the robot R.

As shown in FIG. 14a, a service code subordinate to a corresponding control parameter may be matched to the control parameter and exist as a pair.

A service code is information that identifies the robot R to be controlled according to a control parameter, and may be understood as information that identifies a robot service type (or robot service type).

For example, in the present disclosure, a service code may be defined as “cafe”, “lunch box”, “delivery”, or the like.

However, this is merely an example for convenience of explanation, and the service code may be variously defined according to the service type provided by the robot R.

The control unit 330 may identify, based on the service code matched to the target control parameter, the robot R to which a task corresponding to the service code is assigned as the target robot to be controlled according to the target control parameter.

The control unit 330 may then transmit the target control parameter to the target robot R.

For example, as shown in FIG. 14a, assume that the “Robot Sound On (sound activation)” 510 control parameter and the “cafe” 510a service code are matched to the “N5” node.

The control unit 330 may identify the robot R as the target robot to be controlled according to the “Robot Sound On (sound activation)” 510 target control parameter based on the task assigned to the robot R located at the “N5” node corresponding to the service code “cafe” 510a matched to the target control parameter, and transmit the target control parameter to the robot R.

In this case, the acoustic output unit of the robot R may be switched from a deactivated state to an activated state.

In contrast, if the service code matched to the control parameter does not correspond to the task performed by the robot R, the control unit 330 may restrict transmission of the control parameter to the robot R even when the robot R is located at the node to which the control parameter is assigned.

That is, the control unit 330 may continuously perform only control of the traveling of the robot R, and may not additionally perform control of behaviors other than traveling.

For example, as shown in FIG. 14b, even if the robot R is located at the “N5” node to which the control parameter 510 is assigned, if the robot R is not a robot performing a task corresponding to the service code “cafe” 510a matched to the control parameter 510, the control unit 330 may restrict transmission of the control parameter 510 to the robot R.

In this case, the acoustic output unit of the robot R may continue to remain in a deactivated state.

Furthermore, a plurality of service codes may be matched to one specific control parameter.

At the “N7” node, three service codes of “cafe”, “delivery”, and “lunch box” 520a may be matched to the “Turn Left (rotate to the left)” 520 control parameter.

The control unit 330 may transmit the “Turn Left (rotate to the left)” 520 control parameter to the robot R when the task assigned to the robot R corresponds to any one of the three service codes “cafe”, “delivery”, and “lunch box” 520a.

The control unit 330 may receive settings of control parameters and service codes for each node from a user (or system administrator).

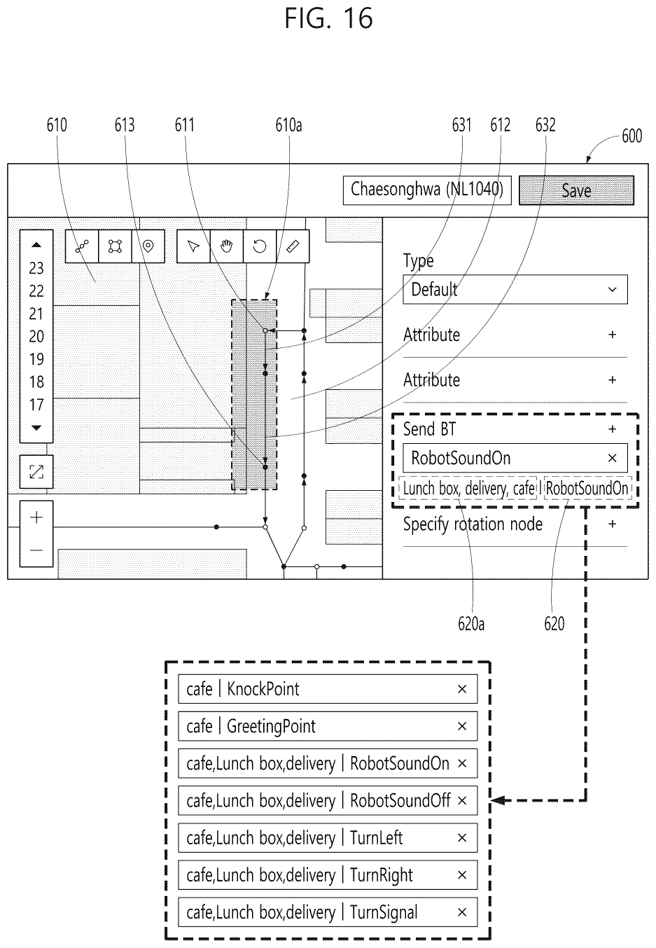

To this end, as shown in FIG. 16, the control unit 330 may provide an interface (or editing interface) 600 including a node map 610 to a user terminal.

The control unit 330 may assign (or match) the input control parameter and service code to the selected node 611 based on a control parameter (Robot Sound On) 620 and a service code (lunch box, delivery, cafe) 620a being input by the user while at least one node 611 among the plurality of nodes included in the node map 610 is selected.

The control unit 330 may also collectively assign control parameters and service codes to a plurality of nodes.

The control unit 330 may assign the same control parameter 620 and service code 620a to nodes 611, 612, 613 included in the identified map area 610a when a plurality of nodes 611, 612, 613 are selected on the node map 610 or a map area 610a is identified.

The combination of a control parameter and a service code may be made in various ways.

A user may variously set combinations of “node-control parameter-service code” such as a combination of “Knock Point (perform knock interaction)” and “cafe”, a combination of “Greeting Point (perform greeting interaction)” and “cafe”, and a combination of “Robot Sound On (sound activation)” and “cafe, lunch box, delivery”, so that a robot R performing a task corresponding to a specific service operates according to a specific control parameter when located at a specific node during traveling.

For example, the control unit 330 may assign a control parameter related to on-off of an acoustic output unit of the robot to an exit node of an elevator (refer to reference numeral “204” in FIG. 8) provided in the space 10 according to a user's settings.

In this case, the control unit 330 may assign different control parameters related to on-off of the acoustic output unit 140 to each elevator exit node on each floor.

For example, a control parameter for acoustic output unit off (or Robot Sound Off) may be assigned to the elevator exit node of an office floor, and a control parameter for acoustic output unit on (or Robot Sound On) may be assigned to the elevator 204 exit node of a floor on which a cafe or restaurant is located.

The robot R exiting the elevator 204 may turn off (or deactivate) and turn on (or activate) the acoustic output unit 140 based on entering the elevator exit node.

As another example, assume that a part of the space 10 corresponds to a conference room.

The control unit 330 may assign a knock interaction control parameter (e.g., “Knock Point”) of the robot to an entry node of the conference room.

Before entering the conference room, the robot R may output a knock sound at the entry node of the conference room to notify that a user or the robot R has arrived in the conference room.

As yet another example, a control parameter for outputting a light and a screen corresponding to a turn signal may be assigned to a node on the path where a right turn or left turn is required.

In the present disclosure, a pair of a control parameter and a service code assigned to a node may be referred to as a control data set or behavioral trigger information.

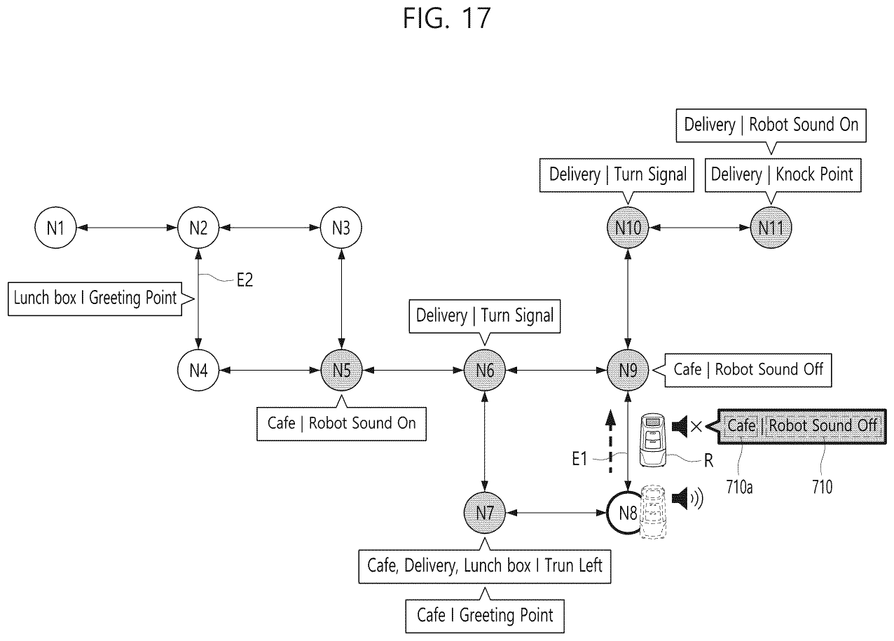

As shown in FIG. 17, the node map may include a plurality of nodes N1, N2, N3 and edges Edge, E1, E2 connecting the nodes.

In the present disclosure, an edge may refer to information defining another node (e.g., “N7” or “N9”) to which the robot R can move from a specific node (e.g., “N8”), and may also be referred to as connection information.

A node and an edge may include specific coordinate information on a map (or space).

The control unit 330 may additionally, in parallel, and simultaneously perform behavior control of the robot R according to the corresponding control parameter together with driving control, based on the robot R traveling in the space 10 along the travel path being located at an edge to which the control parameter is assigned.

The control unit 330 may determine, by using the location information of the robot R, at which element (node or edge) among a plurality of nodes and a plurality of edges the robot R is located.

That is, the control unit 330 may determine at which element among a plurality of elements including nodes and edges the robot R is located.

Since the method for controlling the robot R based on the ‘node’ element has been described above, the following description will be made based on the ‘edge’element.

There may be various methods for determining that the robot R is located at a specific edge.

For example, when the robot R is located between a plurality of adjacent nodes (“N8” and “N9”), the control unit 330 may determine that the robot R is located at the edge E1 connecting the plurality of nodes (“N8” and “N9”).

As another example, when the robot R located between the plurality of nodes (“N8” and “N9”) is located outside a preset distance (or error range) from each of the plurality of nodes (“N8” and “N9”), the control unit 330 may determine that the robot R is located at the edge E1 connecting the plurality of nodes (“N8” and “N9”).

As yet another example, when the robot R is traveling to the next node (e.g., “N9”) via a specific node (e.g., “N8”) included in the travel path, the control unit 330 may determine that the robot R is located at the edge E1 connecting the specific node (e.g., “N8”) and the next node (e.g., “N9”).

There may be various methods for determining whether the robot R is located at an edge.

In the present disclosure, for convenience of explanation, the edge identified as the one at which the robot R is located may be referred to as a “target edge”.

The control unit 330 may additionally, in parallel, and simultaneously perform behavior control of the robot R together with driving control so that the robot R behaves according to the control parameter, based on a control parameter being assigned to the target edge E1 at which the robot R is located, while performing driving control of the robot R so that the robot R travels along the travel path.

The control unit 330 may check whether a control parameter is assigned to the target edge at which the robot R is located.

As a result of the check, if a control parameter is assigned to the target edge, the control unit 330 may transmit the control parameter to the robot R.

In this case, the control unit 330 may control the robot R so that the robot R performs a behavior according to the control parameter assigned to the target edge simultaneously with traveling.

For example, as shown in FIG. 17, when the robot R is located at the “E1” target edge, the control unit 330 may control the robot R so that the robot R performs the “Robot Sound On (sound activation)” 510 behavior while traveling.

On the other hand, if a control parameter is not assigned to the target edge at which the robot R is located, the control unit 330 may not perform additional behavior control of the robot R and may continuously perform only driving control.

When a control parameter (hereinafter may be referred to as a “target control parameter”) is assigned to the target edge at which the robot R is located, the control unit 330 may transmit the target control parameter to the robot R based on the task performed by the robot R corresponding to the service code matched to the control parameter.

For example, as shown in FIG. 17, assume that the “Robot Sound Off (sound deactivation)” 710 target control parameter and the “cafe” 710a service code are matched to the “E1” edge at which the robot R is located.

The control unit 330 may identify the robot R as the target robot to be controlled according to the target control parameter 710 based on the task of the robot R corresponding to the service code “cafe” 710a matched to the target control parameter.

The control unit 330 may then transmit the target control parameter 710 to the target robot R.

In this case, the acoustic output unit of the robot R may be switched from an activated state to a deactivated state.

In contrast, if the task of the robot R (e.g., delivery service) does not correspond to the service code (“cafe”) 710a matched to the target control parameter 710, the control unit 330 may restrict transmission of the control parameter to the robot R even when the robot R is located at the edge to which the control parameter is assigned.

In this case, the state of the acoustic output unit of the robot R may continue to be maintained in the previous state (e.g., activated).

The control unit 330 may receive settings of a control parameter and a service code for an edge from a user (or system administrator).

As described above, the control unit 330 may provide an interface (or editing interface) 600 including a node map 610 to a user terminal (refer to FIG. 16).

The control unit 330 may assign (or match) the control parameter and service code input to the selected node 611 based on a control parameter (Robot Sound On (sound activation) 620) and a service code (lunch box, delivery, cafe) 620a being input by the user while at least one 631 of the plurality of edges included in the node map 610 is selected.

In addition, the control unit 330 may collectively assign control parameters and service codes to a plurality of edges and nodes.

The control unit 330 may assign the same control parameter 620 and service code 620a to nodes 611, 612, 613 and edges 631, 632 included in the identified map area 610a when the map area 610a is identified on the node map 610.

In this case, in the present disclosure, it may be understood that the control parameter 620 and the service code 620a are assigned based on the specific map area 610a.

As such, in the present disclosure, a control parameter and a service code may be assigned to an edge in the same manner as a node, and control of the robot R may be performed according to the control parameter and the service code based on the robot R being located at the corresponding edge.

Accordingly, in the following description, for convenience of explanation, ‘node’ is used as the main subject for continued description; however, it is natural that the content regarding the node may be applied to the ‘edge’ in the same manner.

The control unit 330 may terminate behavior control of the robot R based on the robot R being located at a new different node or being located at a node to which a different control parameter conflicting with the current control parameter is assigned.

The control unit 330 may terminate behavior control according to the control parameter assigned to the previous node when the robot R is located at a new node, while simultaneously performing driving control and behavior control of the robot R.

When the robot R leaves the previous node and moves to a new next node, the control unit 330 may transmit a control command to the robot R so that the behavior according to the control parameter assigned to the previous node is terminated.

That is, the control unit 330 may refresh or reset the behavior control of the robot R.

The robot may continue to travel along the preset travel path even when the behavior according to the control parameter is terminated.

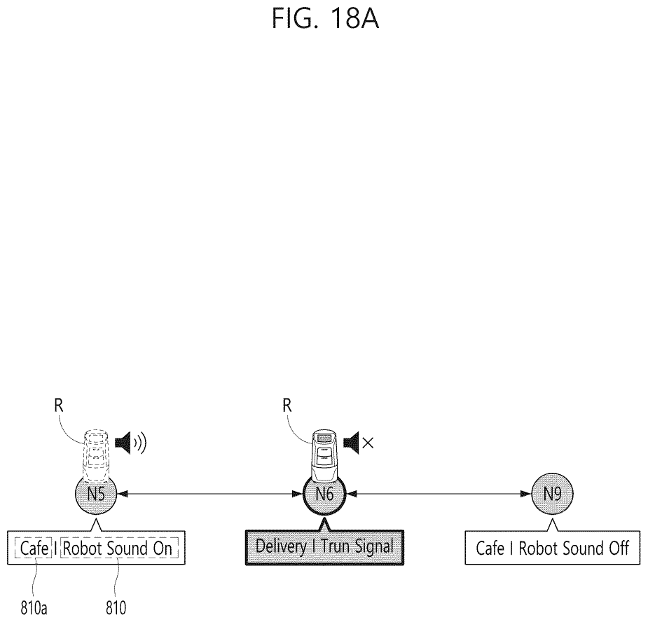

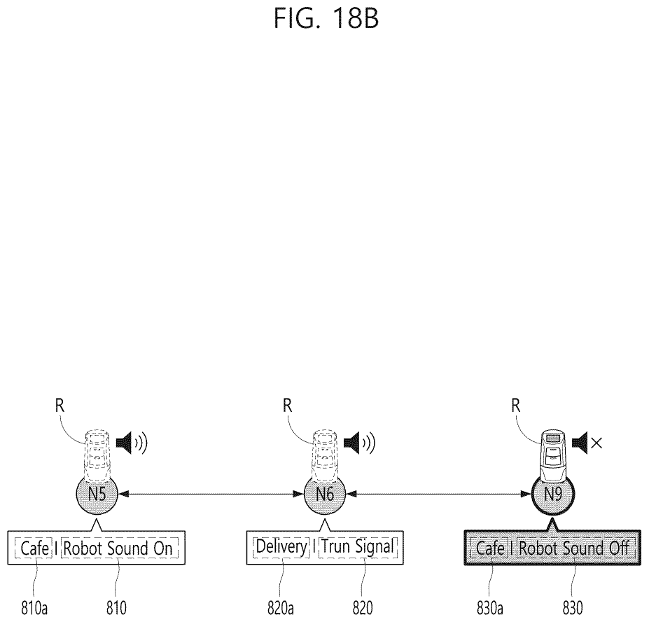

For example, as shown in FIG. 18a, assume that behavior control according to the “Robot Sound On (sound activation)” 810 control parameter has been performed for the robot R based on the robot R being located at a first node N5 to which the control parameter “Robot Sound On (sound activation)” 810 and the service code “cafe” 510a are assigned.

The control unit 330 may terminate the “Robot Sound On (sound activation)” 810 behavior control of the robot R based on the robot R moving from the first node N5 to the second node N6.

In this case, the robot R may set the acoustic output unit provided in the robot R to an activated state at the first node N5, and switch the state of the acoustic output unit provided in the robot R from activated to deactivated at the second node N6.

Although not shown, if the same control parameter as that of the previous node is assigned to the new node at which the robot R is located, the control unit 330 may continue to maintain, without terminating, the behavior control of the robot R that was started at the previous node.

In this case, it may be premised that a service code corresponding to the task of the robot R is matched to the control parameter assigned to the new node.

That is, the control unit 330 may control the behavior control of the robot R according to the previous control parameter to be maintained until the robot R is located at a new node to which a control parameter different from the control parameter assigned to the previous node is assigned, or to which no control parameter is assigned at all.

As described above, the control unit 330 may collectively assign control parameters and service codes to a plurality of nodes 611, 612, 613 in the node map 610 of the editing interface 600.

Accordingly, when the robot R is consecutively located at a plurality of nodes 611, 612, 613 to which the same control parameter and service code are assigned, the control unit 330 may maintain the behavior control according to the corresponding control parameter without terminating it.

Furthermore, although not shown, when the robot R is located at a new node to which a control parameter different from the control parameter assigned to the previous node is assigned, the control unit 330 may terminate the behavior control according to the control parameter assigned to the previous node and start behavior control according to the control parameter assigned to the new node.

In this case, a service code corresponding to the task of the robot R may be matched to the control parameter assigned to the new node.

The control unit 330 may continue to perform driving control of the robot R together with controlling the behavior of the robot R according to the control parameter assigned to the new node.

That is, the control unit 330 may change the behavior control of the robot R from the control parameter assigned to the previous node to the control parameter assigned to the new node, while maintaining the driving control of the robot R.

More specifically, when the robot R is located at a new node while the control unit 330 is performing behavior control according to the control parameter assigned to the previous node simultaneously with driving control of the robot R, the control unit 330 may maintain the driving control of the robot R while terminating the behavior control according to the previous node, and perform behavior control according to the control parameter assigned to the new node in parallel simultaneously with the driving control.

The control unit 330 may continue to maintain the behavior control started at the previous node until the robot R is located at a new node to which a conflicting control parameter is assigned.

In this case, it may be premised that the service code matched to the conflicting control parameter corresponds to the task of the robot R.

More specifically, when the robot R is located at a new node to which a control parameter conflicting with the control parameter assigned to the previous node is assigned, while the control unit 330 is simultaneously performing driving control and behavior control of the robot R, the control unit 330 may terminate the behavior control according to the control parameter assigned to the previous node.

On the other hand, if the control parameter assigned to the new node at which the robot R is located does not conflict with the control parameter assigned to the previous node, the control unit 330 may continue to maintain the behavior control according to the control parameter assigned to the previous node.

For example, as shown in FIG. 18b, assume that behavior control according to the “Robot Sound On (sound activation)” 510 control parameter has been performed for the robot R based on the robot R being located at a first node N5 to which the control parameter “Robot Sound On (sound activation)” 810 and the service code “cafe” 810a are assigned.

Even when the robot R moves from the first node N5 to the second node N6, the control unit 330 may continue to maintain, without terminating, the behavior control according to the control parameter 810 assigned to the first node N5, based on the control parameter “Turn Signal (signal activation)” 820 that does not conflict with the first node N5 being assigned to the second node N6.

And, when the robot R is located at a third node N9 to which “Robot Sound Off (sound deactivation)” 830 conflicting with the control parameter 810 of the first node N5 is assigned, the control unit 330 may terminate the behavior control according to the control parameter 810 of the first node N5.

In this case, the service code 830a matched to the control parameter 830 of the third node N9 may correspond to the task of the robot R.

Furthermore, although not shown, when a new control parameter that does not conflict with the control parameter assigned to the previous node is assigned to a new node at which the robot R is located, and a service code corresponding to the task of the robot R is matched to the new control parameter, the control unit 330 may additionally perform behavior control according to the new node in addition to the behavior control according to the previous node.

For example, assume that the robot R is located at a new node to which a non-conflicting “Turn Signal (signal activation)” control parameter is assigned, while behavior control of the robot R is being performed according to the “Robot Sound On (sound activation)” control parameter assigned to the previous node.

The control unit 330 may further perform additional control so that a signal module (e.g., a lighting unit, a display unit, etc.) of the robot R is activated, while controlling the acoustic output unit of the robot R to remain in an activated state.

A plurality of control parameters may be assigned to and exist at a single node.

If a first control parameter and a second control parameter are assigned to the target node at which the robot R is located, the control unit 330 may determine whether the robot R is the target robot R for each of the first control parameter and the second control parameter.

More specifically, the control unit 330 may determine whether the first service code matched to the first control parameter corresponds to the task of the robot R, and may determine whether the second service code matched to the second control parameter corresponds to the task of the robot R, respectively.

The control unit 330 may transmit, to the robot R, the control parameter to which the service code corresponding to the task of the robot R is matched.

The control unit 330 may control the robot R so that behaviors according to the first control parameter and the second control parameter are performed sequentially or simultaneously.

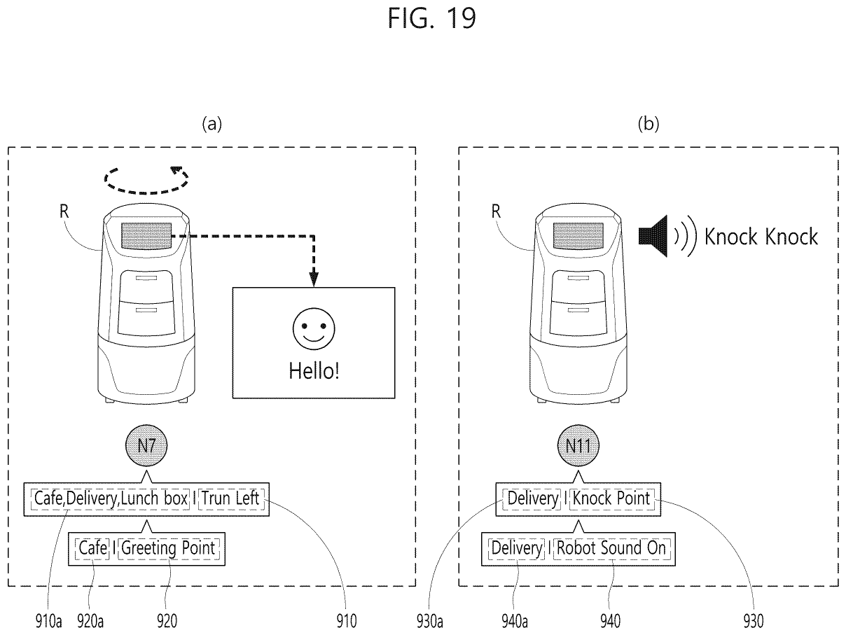

For example, as shown in FIG. 19(a), assume that “Turn Left (rotate to the left)” 910—“cafe, delivery, lunch box 910a” and “Greeting Point (perform greeting interaction)” 920—“cafe” 920a are assigned to the “N7” node, and the task of the robot R corresponds to the “cafe” service code.

Based on the task of the robot R corresponding to the service codes 910a, 920a of “Turn Left (rotate to the left)” 910 and “Greeting Point (perform greeting interaction)” 920, the control unit 330 may transmit the “Turn Left (rotate to the left)” 910 and “Greeting Point (perform greeting interaction)” 920 control parameters to the robot R so that the robot R rotates to the left and performs a greeting interaction.

As another example, as shown in FIG. 19(b), assume that “Knock Point (perform knock interaction)” 930—“delivery” 930a and “Robot Sound On (sound activation)” 950—“delivery” 940a are assigned to the “N11” node, and the task of the robot R corresponds to the “delivery” service code.

Based on the task of the robot R corresponding to the service codes 930a, 940a of “Knock Point (perform knock interaction)” 930 and “Robot Sound On (sound activation)” 950, the control unit 330 may transmit the “Knock Point (perform knock interaction)” 930 and “Robot Sound On (sound activation)” 950 control parameters to the robot R so that the robot R performs a knock interaction while switching the acoustic output unit to an activated state.

Although not shown, if the task of the robot R corresponds only to the first service code among the first service code matched to the first control parameter and the second service code matched to the second control parameter, the control unit 330 may transmit only the first control parameter to the robot R.

In addition, if neither the first service code nor the second service code corresponds to the task of the robot R, the control unit 330 may restrict transmission of both the first control parameter and the second control parameter.

As described above, the control unit 330 may determine that the robot R is located at a specific node based on the robot R being located within a certain distance (or error range) from the specific node.

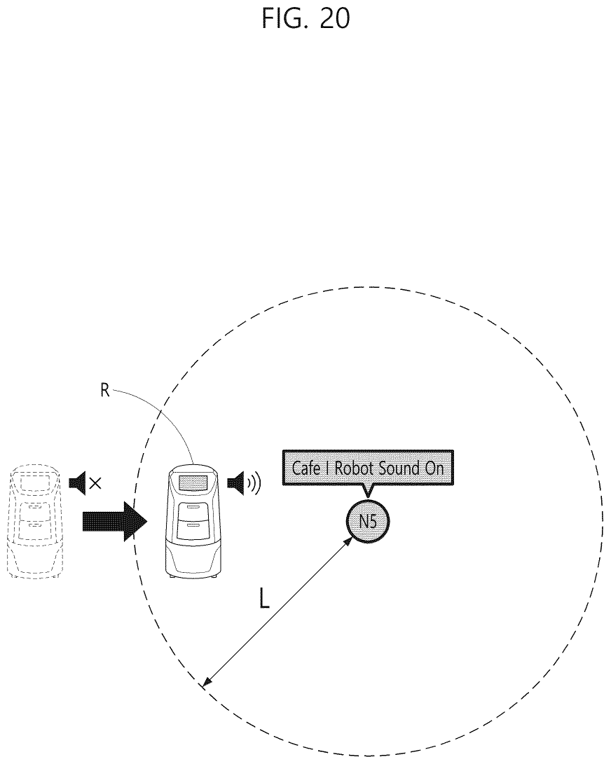

As shown in FIG. 20, when the robot R is traveling toward a specific node N5 along the travel path, the control unit 330 may identify the robot R as being located at the specific node N5 based on the robot R approaching within a certain distance (e.g., L) from the specific node N5.

That is, the control unit 330 may assign a control parameter to the robot R at the moment of entering the specific node N5.

The certain distance L or error range may be set in various ways.

For example, the control unit 330 may set a certain distance based on the nodes included in the travel path of the robot R, the travel speed of the robot R, the distance between a specific node and a previous node, and the like.

The building, the method for controlling a robot traveling in a building, and the system according to the present disclosure control a robot traveling in a space based on a node map including a plurality of nodes, receive location information of the robot traveling in the space along a preset travel path, and may identify a node at which the robot is located based on the location information.

As a result, the present disclosure may control the behavior of a traveling robot based on various locations on the travel path of the robot.

Furthermore, the method and system for controlling a robot according to the present disclosure may control the traveling and behavior of the robot in parallel using the node map by transmitting, to the robot, a control parameter assigned to the identified node when a control parameter related to behavior control of the robot is assigned to the identified node, so that the robot performs a behavior according to the control parameter, and may control the robot to perform a new behavior even when the robot is moving toward a destination or does not stop at a specific location.

The present disclosure described above may be implemented as a program that is executed by one or more processes in a computer and is storable in a computer-readable medium.

Furthermore, the present disclosure described above may be implemented as computer-readable code or instructions on a medium on which a program is recorded.

That is, the various control methods according to the present disclosure may be provided in an integrated or individual form of a program.

The computer-readable medium includes all types of recording devices in which data that can be read by a computer system is stored.

Examples of computer-readable media include HDD (Hard Disk Drive), SSD (Solid State Disk), SDD (Silicon Disk Drive), ROM, RAM, CD-ROM, magnetic tape, floppy disk, optical data storage devices, and the like.

Furthermore, the computer-readable medium may be a server or cloud storage that includes storage and is accessible by an electronic device through communication.

In this case, the computer may download a program according to the present disclosure from the server or cloud storage through wired or wireless communication.

Furthermore, in the present disclosure, the computer described above is an electronic device equipped with a processor, that is, a CPU (Central Processing Unit), and no particular limitation is placed on the type thereof.

The detailed description above should not be construed as restrictive in all respects and should be considered as illustrative.

The scope of the present disclosure should be determined by reasonable interpretation of the appended claims, and all modifications within the equivalent scope of the present disclosure are included in the scope of the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for controlling a robot traveling in a space based on a node map including a plurality of nodes, the method comprising:
receiving location information of the robot traveling in the space along a preset travel path including a plurality of nodes;
identifying a node at which the robot is located based on the location information; and
transmitting, to the robot, a control parameter assigned to the identified node when a control parameter related to behavior control of the robot is assigned to the identified node, so that the robot performs a behavior according to the control parameter.

2. The method of claim 1, wherein the control parameter is related to control of at least one of on-off of an acoustic output unit of the robot, rotation of the robot, a greeting interaction of the robot, and a knock interaction of the robot.

3. The method of claim 2, wherein the identified node is one of the plurality of nodes included in the preset travel path, and when the control parameter is assigned to the identified node, the robot continues to travel along the preset travel path while performing a behavior according to the control parameter.

4. The method of claim 3, further comprising:
terminating a behavior of the robot according to the control parameter based on new location information of the robot, wherein the robot continues to travel along the preset travel path even when the behavior according to the control parameter is terminated.

5. The method of claim 4, wherein in the terminating of the behavior of the robot, the behavior of the robot according to the control parameter is terminated based on the robot being located at a new node different from the identified node.

6. The method of claim 4, wherein when the control parameter assigned to the identified node is related to on-off of an acoustic output unit of the robot, in the terminating of the behavior of the robot, the behavior of the robot is terminated based on a control parameter assigned to a new node at which the robot is located conflicting with the control parameter assigned to the identified node.

7. The method of claim 1, wherein the transmitting of the control parameter to the robot comprises:
determining whether the robot is a target robot to be controlled according to the control parameter; and transmitting the control parameter to the target robot.

8. The method of claim 7, wherein a task corresponding to any one of a plurality of service types is assigned to the robot, and the target robot is determined based on the task assigned to the robot.

9. The method of claim 8, wherein a service code corresponding to at least one of the plurality of service types is matched to the control parameter, and in the determining of whether the robot is the target robot, the robot is determined to be the target robot based on the task of the robot corresponding to the service code.

10. The method of claim 9, wherein when a first control parameter and a second control parameter different from the first control parameter are assigned to the identified node, in the determining of whether the robot is the target robot, a service code matched to each of the first control parameter and the second control parameter is compared with a service corresponding to the task of the robot.

11. The method of claim 1, wherein in the identifying of the node at which the robot is located, a node existing within a preset error range from a location of the robot among the plurality of nodes is identified as the node at which the robot is located.

12. The method of claim 2, wherein an elevator is provided in the space, the control parameter assigned to an exit node of the elevator is related to on-off of an acoustic output unit of the robot, and the robot located at the exit node of the elevator sets a state of the acoustic output unit to one of activated and deactivated according to the control parameter.

13. The method of claim 2, wherein at least a part of the space corresponds to a conference room, the control parameter assigned to an entry node of the conference room corresponds to a knock interaction of the robot, and the robot located at the entry node of the conference room outputs a knock sound according to the control parameter.

14. The method of claim 1, wherein the node map includes an edge connecting the plurality of nodes, and in the transmitting of the control parameter to the robot, when the robot is located at the edge to which the control parameter is assigned, the control parameter assigned to the edge is transmitted to the robot.

15. The method of claim 14, wherein the robot receiving the control parameter assigned to the edge continues to travel along the edge while performing a behavior according to the control parameter assigned to the edge.

16. A system for controlling a robot traveling in a space based on a node map including a plurality of nodes, the system comprising:
a communication unit configured to receive location information of the robot traveling in the space along a preset travel path including a plurality of nodes; and
a control unit configured to identify a node at which the robot is located based on the location information, and transmit, to the robot, a control parameter assigned to the identified node when a control parameter related to behavior control of the robot is assigned to the identified node, so that the robot performs a behavior according to the control parameter.

17. A building in which a robot controlled by a cloud server travels, wherein the building comprises a communication unit configured to receive location information of the robot traveling in a space along a preset travel path including a plurality of nodes from the cloud server, and the cloud server identifies a node at which the robot is located based on the location information, and transmits, to the robot, a control parameter assigned to the identified node when a control parameter related to behavior control of the robot is assigned to the identified node, so that the robot performs a behavior according to the control parameter.
